(19) United States
(12) Patent Application Publication
(10) Pub. No.: US 2024/0300834 A1
(43) Pub. Date: Sep. 12, 2024

(54) Copolymers and Electrochemical Systems and Methods for the Remediation of Organic Pollutants

(71) Applicant: The Board of Trustees of the University of Illinois, Urbana, IL (US)

(72) Inventors: Xiao Su, Champaign, IL (US); Kwiyong Kim, Champaign, IL (US); Paola Baldaguez Medina, Urbana, IL (US); Johannes Elbert, Urbana, IL (US)

(21) Appl. No.: 18/569,331

(22) PCT Filed: Jun. 9, 2022
(86) PCT No.: PCT/US2022/032838

§ 371 Date: Dec. 12, 2023

Related U.S. Application Data
(60) Provisional application No. 63/210,289, filed on Jun. 14, 2021.

(51) Int. Cl. C02F 1/461

(52) U.S. Cl. CPC C02F 1/46109; C02F 2001/46142; C02F 2001/46161; C02F 2201/46135; C02F 2209/006

(57) ABSTRACT

Redox copolymers for electrochemically-assisted electrosorption and release of an organic micropollutant from a contaminated water source are provided. Electrochemical systems including the redox copolymers immobilized to a first electrode such that the first electrode is configured to be tunable in redox activity, hydrophobicity, fluorophilicity, and/or binding affinity, and to be tunable toward a target molecule, are further provided. Methods of and systems for separating and degrading a target molecule in tandem from a fluid are further provided.

### CROSS-REFERENCE TO RELATED APPLICATIONS

This application claims priority from U.S. Provisional Application Ser. No. 63/210,289 filed on Jun. 14, 2021, the entirety of which is hereby incorporated herein by reference.

### STATEMENT REGARDING FEDERALLY FUNDED RESEARCH

This invention was made with government support under 1931941 awarded by the National Science Foundation. The government has certain rights in the invention.

### BACKGROUND OF THE INVENTION

Poly- and perfluoroalkyl substances contamination poses a significant and growing challenge across the United States. Poly- and perfluoroalkyl substances (“PFAS”) constitute a large group of anthropogenic organic pollutants that have been extensively used since the 1950s. The most abundant PFAS are perfluoroalkyl acids, such as carboxylic or sulfonic acids, which possess at least one negatively charged functional group. PFAS contain oleophobic and hydrophobic characteristics that make PFAS attractive for a range of commercially available products, such as firefighting foams, non-stick cookware, food packaging, and cosmetics, due to their non-stick, anti-flammable, and water-repellant properties.

The chemical structures of PFAS are further characterized by strong carbon-fluoride bonds that, unfortunately, increase the persistence of the PFAS in the environment, including in soil, landfills, air, and water, and the potential toxicity and bioaccumulation of PFAS have caused global concern. PFAS do not naturally degrade but remain in the environment for an indefinite period. Contaminated water has been suspected to be the primary route of exposure of PFAS to humans. Moreover, research suggests that high levels of certain PFAS may lead to the following in humans: increased cholesterol levels; changes in liver enzymes; small decreases in infant birth weights; decreased vaccine response in children; increased risk of high blood pressure or pre-eclampsia in pregnant women; and increased risk of kidney or testicular cancer.

Though the U.S. Environmental Protection Agency (“EPA”) declared advisory levels of FPAS for drinking water of 70 ng/L so as to reduce the spread of PFAS into consumable water, PFAS have been detected in aquatic and drinking water at levels greatly surpassing the EPA standard. Surface water in the United States has been found to contain levels of PFAS up to 2,000 ng/L, and surface water foams have been found to contain levels of PFAS of up to 97,000 ng/L. Ground water has been found to contain PFAS in levels as high as 5,200 ng/L. Numerous studies have even demonstrated the presence of PFAS in human blood serum and wildlife.

The abundance of the pollutants has motivated the search for effective technologies to remediate pollutants such as PFAS. Most studies of PFAS adsorption and destruction focused on perfluorooctanoic acid (“PFOA”) and perfluorooctanesulfonic acid (“PFOS”). With increasingly stringent regulations of PFOA and PFOS, there has been an increase in the use of short-chain PFAS, such as hexafluoropropylene oxide dimer acid (“HFPO-DA”). HFPO-DA has increasingly been detected in water and persisted in the environment.

The molecular properties of HFPO-DA have resulted in challenges for separation and environmental remediation due to the shorter backbone of HFPO-DA as well as the middle ether bond, which makes HFPO-DA more hydrophilic and more mobile in the environment compared to longer-chain PFAS. HFPO-DA also demonstrates high water solubility and a pKₐ of 2.84, which provides HFPO-DA with a negative charge over a wide pH range.

Various non-destructive methods have been developed for the selective separation of organic anions such as PFAS from wastewater, including: Activated Carbon Treatment, Ion Exchange Treatment, and High-pressure Membranes. Water remediation of short-chain PFAS such as HFPO-DA by conventional adsorption techniques currently suffer from regeneration efficiency and limited molecular selectivity. Activated Carbon is more successful on longer-chain PFAS such as PFOA and PFOS. Ion Exchange has been demonstrated to have a high capacity for many PFAS, but is typically more expensive than Activated Carbon. High Pressure Membranes, such as nanofiltration or reverse osmosis, have been extremely effective at removing PFAS, but a high volume high-strength waste stream may be difficult to treat or dispose of. Further, traditional chemical adsorption methods require the addition of more chemicals and solvents for regeneration, which raises the operating cost and chemical footprint of the adsorption process.

Accordingly, there is a need for an electrochemical route for separation and remediation of PFAS that is environmentally friendly by reducing energy and chemical costs.

### SUMMARY

In an example, the present disclosure provides a reduction-oxidation (“redox”) copolymer for electrochemically-assisted electrosorption and release of an organic micropollutant from a contaminated water source, the redox copolymer including: a neutral or cationic redox compound; and a cationic compound.

In another example, the present disclosure provides an electrochemical system, including: a first electrode, including a first conductive solid substrate and a first reduction-oxidation (“redox”) copolymer immobilized to the first conductive solid substrate; and a second electrode; wherein the first electrode is configured to be tunable in redox activity, hydrophobicity, and/or binding affinity, and configured to be selective toward a target molecule.

In yet another example, the present disclosure provides a method of separating and degrading a target molecule in tandem from a fluid, including: placing in a fluid source a first electrode and a second electrode, the first electrode including a first solid substrate and a first redox copolymer immobilized to the first solid substrate, and the fluid source including the target molecule; applying an electrical potential across the first electrode and the second electrode such that the first redox copolymer transforms to an oxidized state and selectively binds to a target electron-donating functional group of the target molecule to provide a bound target molecule; and reversing the applied potential such that bound target molecules are released from the first electrode and degraded on a surface of the second electrode.

In yet another example, the present disclosure provides a system for separating and degrading a target molecule in tandem from a fluid, the system including: a first electrode, including a first conductive solid substrate and a first reduction-oxidation (“redox”) copolymer immobilized to the first conductive solid substrate; a second electrode; and a processor; wherein the first electrode is configured to be tunable in redox activity, hydrophobicity, and binding affinity, and configured to be selective toward a target molecule; and wherein the processor is configured to: apply an electrical potential across the first electrode and the second electrode such that the first redox copolymer transforms to an oxidized state and selectively binds to a target electron-donating functional group of the target molecule to provide a bound target molecule; and reverse the applied potential such that bound target molecules are released from the first electrode and degraded on a surface of the second electrode.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The following drawings form part of the specification and are included to further demonstrate certain examples or various aspects of the invention. In some instances, examples of the invention may be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention. The components in the figures are not necessarily to scale. Moreover, in the figures, like-referenced numerals designate corresponding parts throughout the different views.

FIG. 1 illustrates an example of an electrochemical system, prepared according to the principles of the present disclosure;

FIG. 2 illustrates an exploded view of a surface of a first electrode of the electrochemical system illustrated in FIG. 1; and

FIG. 3 illustrates the surface of the first electrode illustrated in FIG. 2 during adsorption under a positive applied potential.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical drawings, such as Hawley's Condensed Chemical Dictionary 14^{th} Edition, by R. J. Lewis, John Wiley & Sons, New York, N.Y., 2001.

References in the specification such as “one example” or “an example” indicate that the example described may include a particular aspect, feature, structure, moiety, or characteristic, but not every example necessarily includes that aspect, feature, structure, moiety, or characteristic. Moreover, such phrases may, but do not necessarily, refer to the same example referred to in other portions of the specification. Further, when a particular aspect, feature, structure, moiety, or characteristic is described in connection with an example, it is within the knowledge of one skilled in the art to affect or connect such aspect, feature, structure, moiety, or characteristic with other examples, whether or not explicitly described.

The singular forms “a,” “an,” and “the” include plural referents unless the context clearly dictates otherwise. Thus, for example, a reference to “a compound” includes plurality of such compounds, so that a compound X includes a plurality of compounds X. it is further noted that the claims may be drafted to exclude any optional element. As such this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The terms “one or more” and “at least one” are readily understood by one of skill in the art, particularly when read in context of its usage. For example, the phrase can mean one, two, three, four, five, six, ten 100, or any upper limit approximately 10, 100, or 1000 times higher than a recited lower limit.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of +5%, +10%, +20%, or +25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include, for example, weight percentages, proximate to the recited range that are equivalent in terms of the functionality of the individual ingredient, composition, or embodiment. The terms “about” and “approximately” can also the modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if “10 to 15” is disclosed, then 11, 12, 13, and 14 are also disclosed, individually, and as part of a range. A recited range (for example, weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third. As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members in a recited group. Accordingly, provisos may apply to any of the disclosed categories or embodiments whereby any one or more of the recited elements, species, or embodiments, may be excluded from such categories or embodiments, for example, for use in an explicit negative limitation.

The terms “cation” and “cationic” refer to a chemical species with a net positive formal charge as a result of the chemical species having fewer electrons than protons.

The terms “anion” and “anionic” refer to a chemical species with a net negative formal charge as a result of the chemical species having more electrons than protons.

The term “neutral” refers to a chemical species with no net formal charge as a result of the chemical species having as many electrons as protons. Individual atoms within the chemical species may bear particular atomic formal charges, such as a “zwitterion,” that ultimately cancel out and result in a neutral chemical species.

The term “alkyl,” by itself or as part of another substituent, means, unless otherwise stated, a straight, branched, or cyclic chain hydrocarbon (“cycloalkyl”) having the number of carbon atoms designated (i.e., “C₁-C₂₀” means one to twenty carbons). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl.

The term “alkylene,” by itself or as part of another substituent, means, unless otherwise stated, a bivalent aliphatic chain radical that is straight, branched, cyclic, or straight or branched and includes a cycloalkyl group, having the number of carbon atoms (i.e., “C₁-C₂₀” means one to twenty carbons) such as methylene (“C₁alkylene,” or “—CH₂—”) or that may be derived from an alkene by opening of a double bond or from an alkane by removal of two hydrogen atoms from different carbon atoms. Examples include methylene, methylmethylene, ethylene, propylene, ethylmethylene, dimethylmethylene, methylethylene, butylene, cyclopropylmethylene, dimethylethylene, and propylmethylene.

The term “alkenyl,” by itself or as part of another substituent, means, unless otherwise stated, a stable mono-unsaturated or di-unsaturated straight chain, the unsaturated meaning a carbon-carbon double bond (—CH═CH—), branched chain, or cyclic hydrocarbon group having the stated number of carbon atoms (i.e., “C₂-C₂₀” means two to twenty carbons). Examples include vinyl, propenyl, allyl, crotyl, isopentenyl, butadienyl, 1,3-pentadienyl, 1,4-pentadienyl, cyclopentenyl, cyclopentadienyl, and the higher homologs and isomers. Functional groups representing an alkene are exemplified by —CH═CH—CH₂— and CH₂—CH—CH₂—.

The term “alkynyl,” by itself or as part of another substituent, means, unless otherwise stated, a stable carbon-carbon triple bond-containing radical (—C≡C—), branched chain, or cyclic hydrocarbon group having the stated number of carbon atoms. Examples include ethynyl and propargyl.

The term “alkoxy,” by itself or as part of another substituent, means, unless otherwise stated, an alkyl group having the designated number of carbon atoms, as defined above, connected to the rest of the molecule via an oxygen atom, such as, for example, methoxy, ethoxy, 1-propoxy, 2-propoxy (“isopropoxy”), and the higher homologs and isomers. Preferred are —(C₁-C₃)alkoxy, particularly ethoxy and methoxy.

“Substituted alkyl” or “substituted cycloalkyl” or “substituted alkenyl” or “substituted alkynyl,” means alkyl or cycloalkyl or alkenyl or alkynyl, respectively, as defined above, substituted by one, two, or three, or more substituents. The substituents may, for example, be selected from the group consisting of halogen, —OH, —NH₂, —N(CH₃)₂, —C(═O)OH, —C(═O)O(C₁-C₄)alkyl, —OC(═O)(C₁-C₄)alkyl, alkoxy, perfluoroalkyl, polyfluoroalkyl, —C(═O)NH₂, —C(O)NH(C₁-C₄)alkyl, —C(O)N((C₁-C₄)alkyl)₂, —NHC(═O)(C₁-C₄)alkyl, —N((C₁-C₄)alkyl)C(═O)(C₁-C₄)alkyl, —SO₂NH₂, —C(═NH)NH₂, —C≡N, and —NO₂. Examples of substituted alkyls, include, but are not limited to, 2,2-difluoromethyl, 2-carboxycyclopentyl, and 3-chloropropyl.

The terms “carbamyl” or “carbamoyl” means the group —C(═O)NR^{a}R^{b}, wherein R^{a} and R^{b} are independently selected from hydrogen or an alkyl, cycloalkyl, alkenyl, or alkynyl functional group, or wherein R^{a} and R^{b} combined form a heterocycle. Examples of carbamyl groups include —C(═O)NH₂ and —C(═O)N(CH₃)₂.

The term “N-amido” means the group —N(R^{c})C(═O)R^{d}, wherein R^{c} is selected from hydrogen or an alkyl, cycloalkyl, alkenyl, or alkynyl functional group denoted by prefix “N—”. Examples of N-amido groups include —N(CH₃)C(═O)CH₃ (“N-methyl”) and —N(CH₂CH₃)C(═O)CH₃ (“N-ethyl”).

The term “carboxy” means the group —OC(═O)Re, wherein Re are independently selected from hydrogen or an alkyl, cycloalkyl, alkenyl, or alkynyl functional group. Examples of carboxy groups include acetoxy and propionoxy.

The term “amine” refers to an organic compound that includes a basic nitrogen atom with a lone pair. Amines in which the basic nitrogen atom is bonded to: one carbon are referred to as “primary amines”; two carbons are referred to as “secondary amines”; and three carbons are referred to as “tertiary amines.” Examples may include triethylamine and aniline.

The term “N,N-amino” means the group —NR^{f}R^{g}, wherein R^{f} and R_{g} are independently selected from an alkyl, cycloalkyl, alkenyl, or alkynyl functional group, or wherein R^{f} and R^{g} combined form a heterocycle. Examples of N-amino groups include —NHCH₃ and —N(CH₃)₂.

The term “N-amino” means the group —NHR^{f}.

The term “cyano” refers to a —C≡N group.

The term “halo” or “halogen,” mean, unless otherwise stated, a monovalent fluorine, chlorine, brome, or iodine atom.

The term “polyfluorinated” means an organic chemical compound or moiety containing both carbon-hydrogen bonds and more than one carbon-fluorine bond. The term “perfluorinated” is a polyfluorinated organic chemical compound or moiety in which carbon is bonded only to fluorine atoms instead of any hydrogen atoms.

The term “aromatic” generally refers to a carbocycle or heterocycle having one or more polyunsaturated rings having (4n+2) delocalized π (pi) electrons wherein n is an integer.

The term “aryl” refers to a carbocyclic aromatic system containing one or more rings (typically one, two, or three rings) wherein such rings may be attached together in a pendant manner, such as biphenyl, or may be fused, such as napththalene. Examples include pheny; anthracyl; and naphthyl. Preferred are phenyl and naphthyl; most preferred is phenyl.

The terms “heterocycle” or “heterocyclyl” or “heterocyclic,” by themselves or as part of other substituents, mean, unless otherwise stated, an unsubstituted or substituted, stable, mono- or multi-cyclic heterocyclic ring system that consists of carbon atoms and at least one heteroatom independently selected from the group consisting of N, O, and S, and wherein the nitrogen and sulfur heteroatoms may be optionally oxidized, and the nitrogen atom may be optionally quaternized. The heterocyclic system may be attached, unless otherwise stated, at any heteroatom or carbon atom that affords a stable structure.

The terms “heteroaryl” or “heteroaromatic,” by themselves or as part of other substituents, refer, unless otherwise stated, to a heterocyclic having aromatic character. A polycyclic heteroaryl may include fused rings. Examples include indole, 1H-indazole, 1H-pyrrolo[2,3-b]pyridine, and the like. A polycyclic heteroaryl may include one or more rings that are partially saturated. Examples include indoline, tetrahydroquinoline, and 2,3-dihydrobenzofuryl.

Non-limiting examples of non-aromatic heterocycles include monocyclic groups such as: aziridine, oxirane, thiirane, azetidine, oxetane, thietane, pyrrolidine, pyrroline, imidazoline, pyrazolidine, dioxolane, sulfolane, 2,3-dihydrofuran, 2,5-dihydrofuran, tetrahydrofuran, thiophane, piperidine, 1,2,3,6-tetrahydropyridine, piperazine, N-methylpiperazine, morpholine, thiomorpholine, pyran, 2,3-dihydropyran, tetrahydropyran, 1,4-dioxane, 1,3-dioxane, homopiperazine, homopiperidine, 1,3-dioxepane, 4,7-dihydro-1,3-dioxepin, and hexamethyleneoxidine.

Non-limiting examples of heteroaryl groups include: pyridyl; pyrazinyl; pyrimidinyl, particularly 2- and 4-pyrimidinyl; pyridazinyl; thienyl; furyl; pyrrolyl, particularly 2-pyrrolyl; imidazolyl; thiazolyl; oxazolyl; pyrazolyl, particularly 3- and 5-pyrazolyl; isothiazolyl; 1,2,3-triazolyl; 1,2,4-triazolyl; 1,3,4-triazolyl; tetrazolyl; 1,2,3-thiadiazolyl; 1,2,3-oxadiazolyl; 1,3,4-thiadiazolyl; and 1,3,4-oxadiazolyl.

Polycyclic heterocycles include both aromatic and non-aromatic polycyclic heterocycles. Non-limiting examples of polycyclic heterocycles include: indolyl, particularly 3-, 4-, 5-, 6-, and 7-indolyl; indolinyl; indazolyl, particularly 1H-indazol-5-yl; quinolyl; tetrahydroquinolyl; isoquinolyl, particularly 1- and 5-isoquinolyl; 1,2,3,4-tetrahydroisoquinolyl; cinnolyl; quinoxalinyl, particularly 2- and 5-quinoxalinyl; quinazolinyl; phthalazinyl; naphthyridinyl, particularly 1,5- and 1,89-naphthyridinyl; 1,4-benzodioxanyl; coumaryl; dihydrocoumaryl; benzofuryl, particularly 3-, 4-, 5-, 6-, and 7-benzofuryl; 2,3-dihydrobenzofuryl; 1,2-benzisoxazoyl; benzothienyl, particularly 3-, 4-, 5-, 6-, and 7-benzothienyl; benzoxazolyl; benzothiazolyl, particularly 2- and 5-benzothiazolyl; purinyl; benzimidazolyl, particularly 2-benzimidazolyl; benztriazolyl; thioxanthinyl; carbazolyl; carbolinyl; acridinyl; pyrrolizidinyl; pyrrolo[2,3-b]pyridinyl, particularly 1H-pyrrolo[2,3-b]pyridin-5-yl; and quinolizidinyl. Particularly preferred are 4-indolyl, 5-indolyl, 6-indolyl, 1H-indazol-5-yl, and 1H-pyrrolo[2,3-b]pyridin-5-yl. The aforementioned listing of heterocyclic and heteroaryl moieties is intended to be representative and not limiting.

For aryl and heteroaryl groups, the term “substituted” refers to any level of substitution, namely mono-, di-, tri-, tetra-, or penta-substitution, where such substitution is permitted. The substituents are independently selected, and substitution may be at any chemically accessible position. For aryl and heteroaryl groups, the term “unsubstituted” refers to no level of substitution where such substitution is permitted.

The term “reduction-oxidation” and the portmanteau thereof, “redox,” mean a type of chemical reaction in which the oxidation states of atoms within reagents change. “Oxidation” refers to the loss of electrons or an increase in the oxidation state of a reagent or atoms thereof. “Reduction” refers to the gain of electrons or a decrease in the oxidation state of a reagent or atoms thereof. Examples of redox reactions may include “electron-transfer” redox reactions in which electrons flow from the reducing agent to the oxidizing agent. The terms “redox activity” and “redox potential” refer to a measure of the tendency of a chemical species to acquire electrons from, or lose electrons to, an electrode and thereby be reduced or oxidized, respectively’

The term “copolymer” means a polymer formed when two different monomers are linked in the same polymer chain.

The term “organic micropollutant,” without limitation, may refer to chemicals including pesticides, pharmaceuticals, detergents, chemical waste, disinfection byproducts.

In certain examples, the term “organic micropollutant” refers to poly- and perfluoroalkyl substances (“PFAS”) including compounds of formula (I):

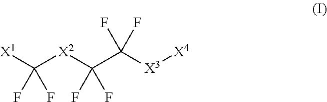

wherein X¹ is chloro or fluoro; X² is a bond between CF₂X¹ and CF₂CF₂X³X⁴, O, C—CF₂, or CₙF₂ₙ wherein n is an integer from 1 to 10; X³ is a bond between CF₂CF₂X²CF₂X¹ and X⁴, ethylene, SO₂—N(CH₃)—CH₂, SO₂—N(CH—CH₃)—CH₂, O—CF(CF₃), O—CF₂—CHF, or O—CF₂—CP₂; and X⁴ is CO₂H, SO₃H, or SO₂NH₂. In other examples, the term “organic micropollutant” refers to a compound including a carboxylate moiety, a sulfonate moiety, or a phosphate moiety. In still other examples, the term “organic micropollutant” refers to a compound selected from Table 1 below:

TABLE 1

| Organic Micropollutant | Abbreviation | CAS No. | Structural Formula |
|---|---|---|---|
| perfluorobutanoic acid | PFBA | 375-22-4 | 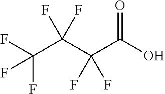 [SMILES: O=C(O)C(F)(F)C(F)(F)C(F)(F)F] |
| perfluoropentanoic acid | PFPeA | 2706-90-3 | 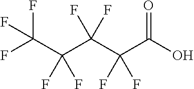 [SMILES: O=C(O)C(F)(F)C(F)(F)C(F)(F)C(F)(F)F] |
| perfluorohexanoic acid | PFHxA | 307-24-4 | 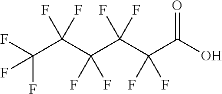 [SMILES: O=C(O)C(F)(F)C(F)(F)C(F)(F)C(F)(F)C(F)(F)F] |
| perfluoroheptanoic acid | PFHpA | 375-85-9 | 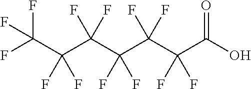 [SMILES: O=C(O)C(F)(F)C(F)(F)C(F)(F)C(F)(F)C(F)(F)C(F)(F)F] |
| perfluorooctanoic acid | PFOA | 335-67-1 | 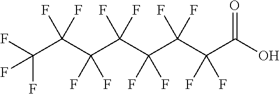 [SMILES: O=C(O)C(F)(F)C(F)(F)C(F)(F)C(F)(F)C(F)(F)C(F)(F)C(F)(F)F] |
| perfluorononanoic acid | PFNA | 375-95-1 | 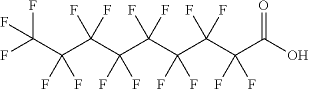 [SMILES: O=C(O)C(F)(F)C(F)(F)C(F)(F)C(F)(F)C(F)(F)C(F)(F)C(F)(F)C(F)(F)F] |
| perfluorodecanoic acid | PFDA | 335-76-2 | 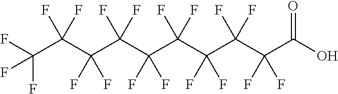 [SMILES: O=C(O)C(F)(F)C(F)(F)C(F)(F)C(F)(F)C(F)(F)C(F)(F)C(F)(F)C(F)(F)C(F)(F)F] |
| perfluoroundecanoic acid | PFUnA | 2058-94-8 | 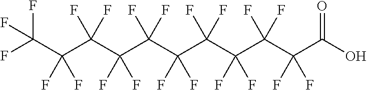 [SMILES: O=C(O)C(F)(F)C(F)(F)C(F)(F)C(F)(F)C(F)(F)C(F)(F)C(F)(F)C(F)(F)C(F)(F)C(F)(F)F] |
| perfluorododecanoic acid | PFDoA | 307-55-1 | 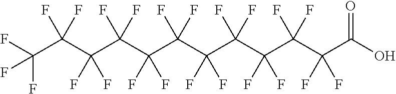 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)F] |
| perfluorotridecanoic acid | PFTrDA | 72629-94-8 | 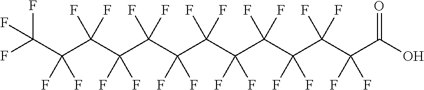 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)F] |
| perfluorotetradecanoic acid | PFTeDA | 376-06-7 | 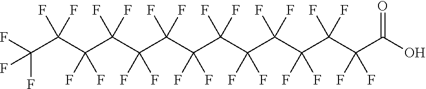 [SMILES: O=C(O)C(F)(F)C(F)(F)C(F)(F)C(F)(F)C(F)(F)C(F)(F)C(F)(F)C(F)(F)C(F)(F)C(F)(F)C(F)(F)C(F)(F)C(F)(F)F] |
| N-methylperfluorooctane sulfonamidoacetic acid | NMeFOSAA | 2355-31-9 | 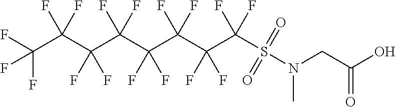 [SMILES: CN(CC(=O)O)S(=O)(=O)C(F)(F)C(F)(F)C(F)(F)C(F)(F)C(F)(F)C(F)(F)C(F)(F)C(F)(F)F] |
| N-ethylperfluorooctane sulfonamidoacetic acid | NEtFOSAA | 2991-50-6 | 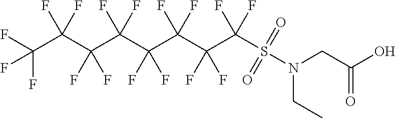 [SMILES: CCN(CC(=O)O)S(=O)(=O)C(F)(F)C(F)(F)C(F)(F)C(F)(F)C(F)(F)C(F)(F)C(F)(F)C(F)(F)F] |
| perfluorooctane- sulfonamide | PFOSA | 754-91-6 | 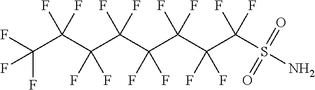 [SMILES: NS(=O)(=O)C(F)(F)C(F)(F)C(F)(F)C(F)(F)C(F)(F)C(F)(F)C(F)(F)C(F)(F)F] |
| perfluorobutanesulfonic acid | PFBS | 375-73-5 | 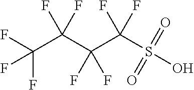 [SMILES: O=S(=O)(O)C(F)(F)C(F)(F)C(F)(F)C(F)(F)F] |
| perfluoropentanesulfonic acid | PFPeS | 2706-91-4 | 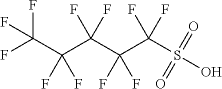 [SMILES: O=S(=O)(O)C(F)(F)C(F)(F)C(F)(F)C(F)(F)C(F)(F)F] |
| perfluorohexanesulfonic acid | PFHxS | 355-46-4 | 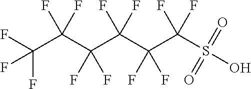 [SMILES: O=S(=O)(O)C(F)(F)C(F)(F)C(F)(F)C(F)(F)C(F)(F)C(F)(F)F] |
| perfluoroheptanesulfonic acid | PFHpS | 375-99-6 | 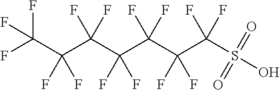 [SMILES: O=S(=O)(O)C(F)(F)C(F)(F)C(F)(F)C(F)(F)C(F)(F)C(F)(F)C(F)(F)F] |
| perfluorooctanesulfonic acid | PFOS | 1763-23-1 | 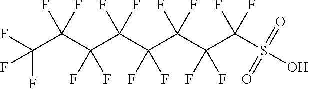 [SMILES: O=S(=O)(O)C(F)(F)C(F)(F)C(F)(F)C(F)(F)C(F)(F)C(F)(F)C(F)(F)C(F)(F)F] |
| perfluorononanesulfonic acid | PFNS | 98789-57-2 | 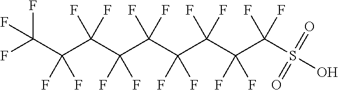 [SMILES: O=S(=O)(O)C(F)(F)C(F)(F)C(F)(F)C(F)(F)C(F)(F)C(F)(F)C(F)(F)C(F)(F)C(F)(F)F] |
| perfluorodecanesulfonic acid | PFDS | 2806-15-7 | 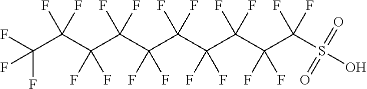 [SMILES: O=S(=O)(O)C(F)(F)C(F)(F)C(F)(F)C(F)(F)C(F)(F)C(F)(F)C(F)(F)C(F)(F)C(F)(F)C(F)(F)F] |
| 4:2 fluorotelomer sulfonic acid | 4:2FTS | BDO-2205 | 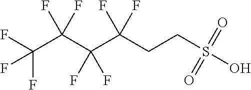 [SMILES: O=S(=O)(O)CCC(F)(F)C(F)(F)C(F)(F)C(F)(F)F] |
| 6:2 fluorotelomer sulfonic acid | 6:2FTS | 27619-97-2 | 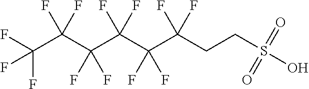 [SMILES: O=S(=O)(O)CCC(F)(F)C(F)(F)C(F)(F)C(F)(F)C(F)(F)C(F)(F)F] |
| 8:2 fluorotelomer sulfonic acid | 8:2FTS | 39108-34-4 | 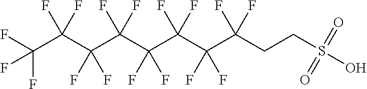 [SMILES: O=S(=O)(O)CCC(F)(F)C(F)(F)C(F)(F)C(F)(F)C(F)(F)C(F)(F)C(F)(F)C(F)(F)F] |
| 11-chloroeicosafluoro-3- oxaundecane-1-sulfonic acid | 11Cl- PF3OUds | 763051-92-9 | 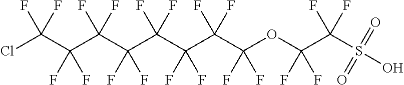 [SMILES: O=S(=O)(O)C(F)(F)C(F)(F)OC(F)(F)C(F)(F)C(F)(F)C(F)(F)C(F)(F)C(F)(F)C(F)(F)C(F)(F)Cl] |
| 9-chlorohexadecafluoro-3- oxanone-1-sulfonic acid | 9C1- PF3ONS | 756426-58-1 | 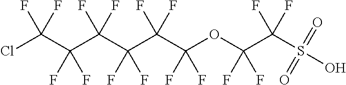 [SMILES: O=S(=O)(O)C(F)(F)C(F)(F)OC(F)(F)C(F)(F)C(F)(F)C(F)(F)C(F)(F)C(F)(F)Cl] |
| 4,8-dioxa-3H- perfluorononanoic acid | ADONA | 919005-14-4 | 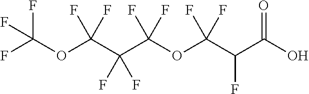 [SMILES: O=C(O)C(F)C(F)(F)OC(F)(F)C(F)(F)C(F)(F)OC(F)(F)F] |
| hexafluoropropylene oxide dimer acid | HFPO-DA (GEN-X) | 13252-13-6 | 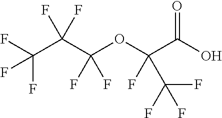 [SMILES: O=C(O)C(F)(OC(F)(F)C(F)(F)C(F)(F)F)C(F)(F)F] |

Examples of redox copolymers of the present disclosure may be configured to selectively bind to a negatively charged functional group of a target molecule when the redox copolymer is neutral or cationic. In certain examples, a redox copolymer of the present disclosure may be made up of two or more different types of monomers, each type of monomer including a different functional group or moiety, such that the redox copolymer is advantageously configured to effectively bind to a particularly functionalized target molecule that may be an organic micropollutant.

As used herein, the term “redox active compound” refers to a first type of monomer included in examples of redox copolymers of the present disclosure. Without being bound by theory, redox active compounds include a redox active functional group or redox active moiety that may be reduced by gain of electrons and/or oxidized by loss of electrons. Examples of redox active compounds of the present disclosure may include cationic redox active compounds, in which the net atomic formal charge is positive, and neutral redox active compounds, in which the net atomic formal charge is zero. Examples of redox active compounds of the present disclosure may include nitroxides, ferrocenes, cobaltocenes, and viologens.

As used herein, the term “nitroxide” refers to a compound including a radical chemical functional group with the general formula R^{h}₂N—O·. The radical chemical functional group of a nitroxide may also commonly be referred to as an “aminoxyl” group. In certain examples, nitroxides may include compounds selected from the group consisting of:

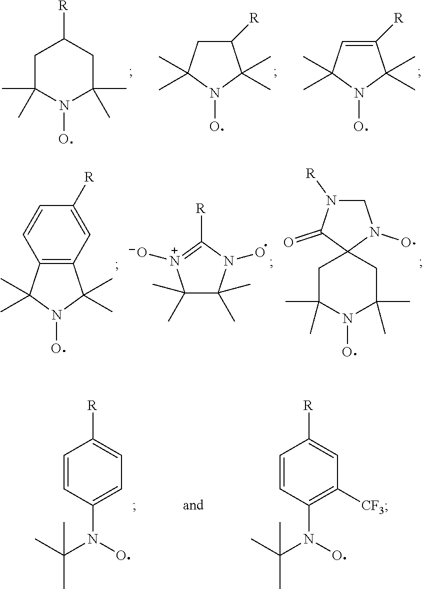

wherein R is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R is substituted with one or more substituents, the one or more substituents may be independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

In a particular example, a nitroxide may be the compound:

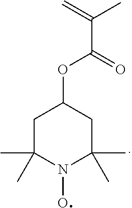

In certain examples, a second type of monomer may include a second type of moiety that is configured to be positively charged at a desired pH. Examples of the second type of monomer may include an amine or an ammonium, including compounds selected from the group consisting of:

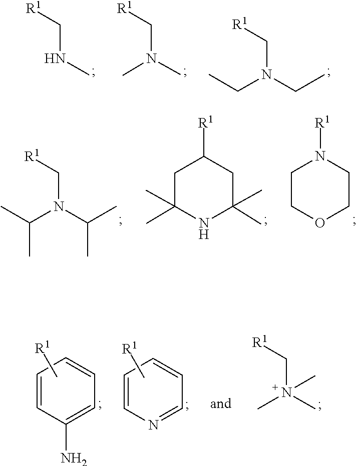

wherein R¹ is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R¹ is substituted with one or more substituents, the one or more substituents may be independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

In a particular example, the second type of monomer may be the compound:

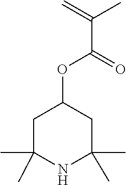

### 2,2,6,6-tetramethylpiperidin-4-yl methacrylate

As used herein, the term “ferrocene” refers to a compound including a chemical moiety including two cyclopentadienyl rings bound to a common iron atom, shown by structural formula as:

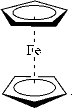

As used herein, the term “cobaltocene” refers to a compound including a chemical moiety including two cyclopentadienyl rings bound to a common cobalt atom, shown by structural formula as:

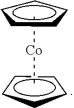

As used herein, the term “viologen” refers to a 4,4′-disubstituted bipyridinium derivative of formula (II):

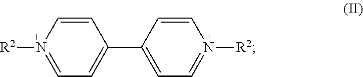

wherein each R¹ is (C₁-C₁₆)alkyl, aryl, heteroaryl, or heterocyclyl.

The term “ammonium” refers to a derivative of an amine in which the basic nitrogen atom with a lone pair instead is bonded to a hydrogen ion or an additional carbon and the nitrogen atom carries a positive formal charge. Examples of ammonium species include the ammonium ion (NH₄⁺) and tetrabutylammonium (Bu₄N⁺).

The term “guanidinium” refers to a derivative of the guanidinium cation, which is the conjugate acid of guanidine. Examples may include the conjugate acids of arginine, triazabicyclodecene, saxitoxin, and creatine. The relationship between a guanidinium, the guanidinium cation, and guanidine is shown by the structural formulas below:

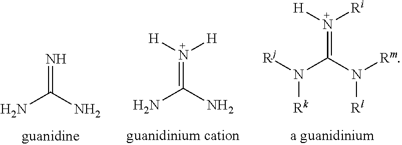

The term “phosphonium” refers to a derivative of the phosphonium cation (PH4+) having up to four organic substituents, such as alkyl and/or aryl substituents, bonded to the central phosphorus atom, which carries a positive formal charge. Examples of phosphonium compounds may include tetraphenylphosphonium and tetramethylphosphonium.

The term “sulfonium” refers to a chemical species including three organic substituents, such as alkyl and/or aryl substituents, bonded to a central sulfur atom, which carries a positive formal charge (Rⁿ₃S⁺). Examples of sulfonium compounds may include S-adenosylmethionine, S-methylmethionine, and dimethylsulfoniopropionate.

The term “carboxylate” refers to a compound including a functional group or moiety with the formula R^{o}CO₂⁻ that is the conjugate base of a carboxylic acid group. Examples of carboxylates may include methyl carboxylate, which is also commonly referred to as “acetate.”

The term “sulfonate” refers to a compound including functional group or moiety with the formula R^{p}SO₃⁻ that is the conjugate base of a sulfonic acid. Examples of sulfonates may include p-toluenesulfonate.

The term “phosphate” refers to an ester of orthophosphoric acid in which one or more hydrogen atoms of the acid are replaced by organic groups. Examples of phosphates may include trimethylphosphate.

The term “hydrophobicity” refers to the physical property of a molecule to be seemingly repelled from a mass of water. Hydrophobic molecules tend to be nonpolar and thus prefer interaction with other neutral molecules and nonpolar solvents. Examples of hydrophobic molecules include alkanes, oils, and fats, and, without being bound by theory, hydrophobicity of a molecule may be increased by addition of one or more long-chain hydrocarbon groups such as (especially branched) alkyl, alkenyl, and/or alkynyl groups.

The term “binding affinity” refers to the rate of binding between chemical species in solution due to the intermolecular forces between the chemical species, including ionic bonds, hydrogen bonds, and Van der Waals forces. Without being bound by theory, binding affinity may be a function of molecular charge, hydrophobicity, and structure.

### Redox Copolymers.

The present disclosure presents a design of redox copolymers for electrochemically-assisted electrosorption and release of organic micropollutants from contaminated water sources. The properties of the redox copolymers may be tuned by controlling the structure of the redox copolymers for the electrochemical treatment of organic micropollutants. The development of molecularly-tuned redox copolymers may be extended to the design of novel electrochemical systems at a process level, enabling tandem capture and degradation via the integration with reactive counter electrodes in a flow-through electrochemical device.

Molecularly-tuned redox copolymers may allow for tuning of physicochemical properties that may be critical for selective separations of organic micropollutants. Controlling the ratio between amine/ammonium moieties and nitroxide moieties may provide a pathway for modulating redox activity, hydrophobicity, and binding affinity of a redox copolymer, to synergistically enhance electrochemically-mediated adsorption and regeneration. Optimal tuning of a redox copolymer may enable devices with an electrochemically-mediated nature for reversible capture and release (up-concentrating) of diverse organic micropollutants—including PFAS and pharmaceuticals—without changing pH or adding chemical agents, and by relying purely on interfacial properties of the copolymer electrode and electrical stimulus, and may be generalized to other redox/conductive polymers, and the tuning of further properties beyond hydrophobicity.

In an example, a redox copolymer may be designed by combining a positively charged group and a redox-active group. The positively charged group may provide binding affinity sites, and the redox-active group may impart reversible redox activity for electrochemically-mediated capture and release. For example, the redox copolymer may be selected from, including, but not limited to, the combination of nitroxide moieties and amine/ammonium moieties listed herein.

### Electrochemical Devices and Systems.

In an example, an electrochemical device including examples of redox copolymer presents an exceptionally high adsorption capacity for PFAS (>1500 mg PFOA/g adsorbent) and separation factors (500 vs. chloride), which represent greater adsorption capacities than currently reported materials for PFAS adsorption. Delicate tuning of a redox copolymer on a working electrode may enable reversible capture and release of PFAS controlled only by electrical potential, exhibiting the cyclable nature of adsorption and desorption without demonstrating a critical loss of working capacity. Electrochemically-assisted release may also allow for up-concentrating a contaminant stream for next-stage treatment processes.

At a process/system level, the working electrodes including redox copolymers may be coupled with a reactive counter electrode, such as boron-doped diamond, to establish an asymmetric electrochemical configuration. The regeneration stage may thereby be coupled with simultaneous destruction of pollutants on the counter electrode. The design of such an electrochemical device may allow for the integration of separation and reactive degradation of organic micropollutants in tandem in a one-unit device. Additionally, the coupled asymmetric design beneficially improves energy efficiency during the degradation due to proper tuning of redox-potential with the redox copolymer electrode, which is not possible using conventional conductive electrodes due to parasitic side reactions. During PFAS capture and release, a system may exhibit high defluorination efficiency (>80%) and F index (12.1), which may be comparable to or higher than traditional electrochemical processes.

The redox copolymers and electrochemical systems of the present disclosure demonstrate efficient selectivity in electrochemical separations and reactions and may be generalizable to diverse PFAS compounds (for example, different terminal groups, structures, C—F chain lengths), and diverse classes of organic micropollutants, including pesticides, pharmaceuticals, detergents, chemical waste, and disinfection byproducts.

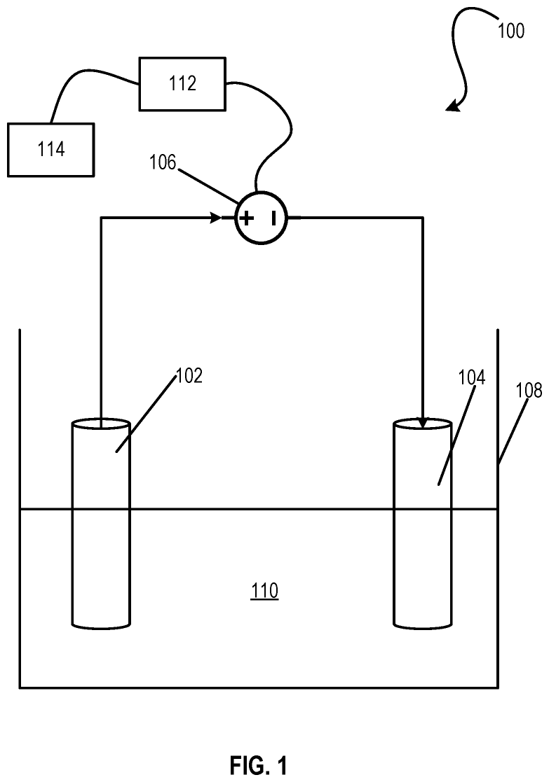

The present disclosure provides electrochemical systems incorporating examples of redox copolymers of the present disclosure. Referring to FIG. 1, an example of an electrochemical system 100 is illustrated. The electrochemical system includes a first electrode 102 and a second electrode 104, which may be a counter electrode to first electrode 102. First electrode 102 and second electrode 104 are partially contacting a fluid 110 in a vessel 108. Fluid 110 may include a target molecule, which may be an organic micropollutant. First electrode 102 is electrically coupled to a power source 106, which is also electrically coupled to second electrode 104.

Examples of target molecules may include a perfluoroalkyl compound, a polyfluoroalkyl compound, a pharmaceutical compound, a personal healthcare product, a detergent, a pesticide, a herbicide, and/or an organic wastewater contaminant.

Examples of electrochemical systems of the present disclosure may additionally include memory 114 and processor 112. Processor 112 may be in communication with memory 114 and a network interface (not shown in FIG. 1). In one example, processor 112 may also be in communication with additional elements, such as a display (not shown in FIG. 1). Examples of processor 112 may include a controller, a general processor, a central processing unit, a microcontroller, a server, an application specific integrated circuit (“ASIC”), a digital signal processor, a field programmable gate array (“FPGA”), a digital circuit, and/or an analog circuit. Processor 112 may be one or more devices operable to execute logic. The logic may include computer executable instructions or computer code embodied in memory 114 or in other memory that, when executed by processor 112, may cause processor 112 to perform the features implemented by the logic. The computer code may include instructions executable with processor 112. The processing capability of electrical systems of the present disclosure may be distributed among multiple entities, such as among multiple processors and memories, optionally including multiple distributed processing systems. Processor 112 may advantageously control power source 106 to apply an electrical potential across first electrode 102 and second electrode 104 or to reverse the applied potential. Second electrode 104 is made from a material such that second electrode 104 may be chemically inert in aqueous media and may demonstrate high overpotential for water-splitting reactions. Examples of the material of which second electrode 104 may be made may include oxides of tin, lead, and/or titanium; platinum; and/or boron-doped diamond.

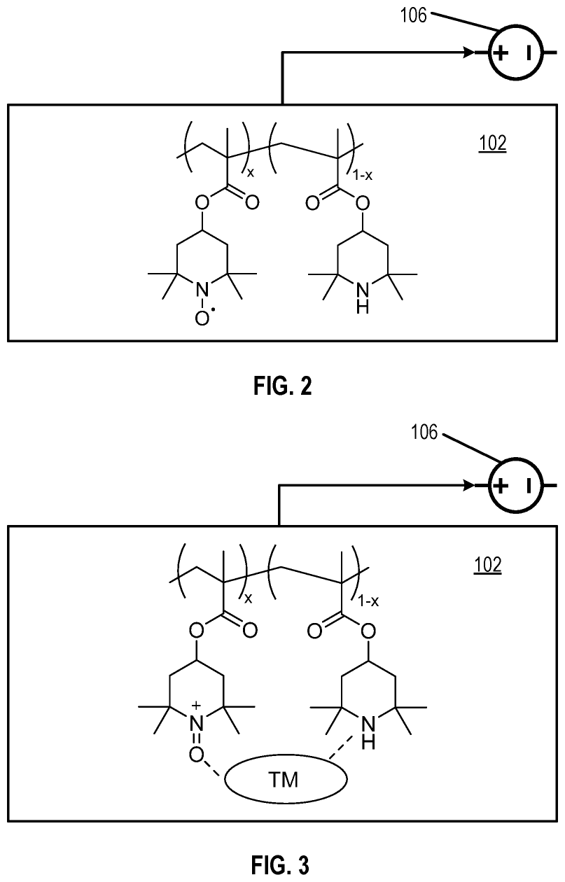

Referring to FIG. 2, an exploded view of a surface of first electrode 102 is illustrated. First electrode 102 includes a conductive solid substrate to which a redox copolymer is immobilized. Examples of conductive solid substrates may include graphite, carbon nanotube(s), and mixtures thereof. As shown in FIG. 2, an example of a redox copolymer may be poly(4-methacryloyloxy-2,2,6,6-tetramethylpiperidin-1-oxyl-co-4-methacryloyloxy-2,2,6,6-tetramethylpiperidine) (p(TMAₓ-co-TMPMA₁₋ₓ)). Upon application of electrical potential from power source 106, the nitroxide moieties of the p(TMAₓ-co-TMPMA₁₋ₓ) are oxidized to oxammonium cations as illustrated in FIG. 3. Consequently, a target molecule (“TM”) may undergo electrosorption and bind to the oxammonium and piperidine moieties of the oxidized redox copolymer. Upon subsequently reversing polarity of power source 106 and applying negative potential, the oxammonium moieties are reduced to nitroxide moieties and the target molecules are released from binding with the redox polymer immobilized on first electrode 102. The target molecule may then be degraded on the surface of second electrode 104.

The present disclosure also provides methods of separating and degrading a target molecule in tandem from a fluid. In an example, a method includes: placing in a fluid source a first electrode and a second electrode, the first electrode including a solid substrate and a redox copolymer immobilized to the solid substrate, and the fluid source including the target molecule; applying an electrical potential across the first electrode and the second electrode such that the redox copolymer transforms to an oxidized state and selectively binds to a target electron-donating functional group of the target molecule to provide a bound target molecule; and reversing the applied potential such that the bound target molecule is released from the first electrode and degraded on a surface of the second electrode. In another example, the reversing includes catalyzing oxidative or reductive degradation of the released target molecule on the surface of the second electrode.

The compositions and processes described above may be better understood in connection with the following Examples. In addition, the following non-limiting examples are an illustration. The illustrated methods are applicable to other examples of redox copolymers, organic micropollutants, target molecules, and electrochemical systems of the present disclosure. The procedures described as general methods describe what is believed will be typically effective to prepare the redox copolymers indicated. However, the person skilled in the art will appreciate that it may be necessary to vary the procedures for any given example of the present disclosure, for example, vary the order or steps and/or the chemical reagents used.

### Examples

### I. Synthesis of p(TMAₓ-co-TMPMA₁₋ₓ)

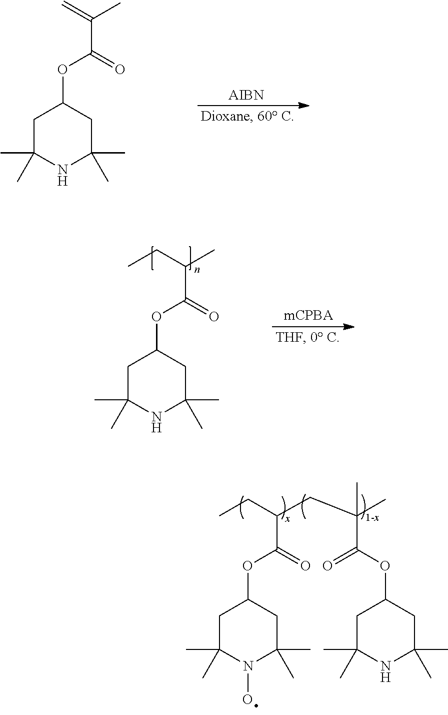

All chemicals were obtained from Sigma Aldrich, VWR, Fisher Scientific, or TCI, and used as received.

### A. Preparation of poly(4-methacryloyloxy-2,2,6,6-tetramethylpiperidine) (pTMPMA)

4-Methacryloyloxy-2,2,6,6-tetramethypiperidine (20 g, 89 mmol) and azobisisobutyronitrile (“AIBN,” 150 mg, 0.89 mmol) were dissolved in 1,4-dioxane (50 mL). The mixture was degassed by the freeze-pump-thaw method and heated to 60° C. for 16 hours. The polymer product was precipitated in Hexane (2 L), filtered, and dried under reduced pressure, yielding 15.7 g (80%) PTMPMA as colorless solid. ¹H NMR (400 MHZ, CDCl₃, δ): 5.13-4.98 (b, 1H; CH—O), 2.10-1.71 (b, 4H; CH₂), 1.48-0.80 (m, b, 17H; CH₂+CH₃).

### B. Preparation of poly(4-methacryloyloxy-2,2,6,6-tetramethylpiperidin-1-oxyl-co-4-methacryloyloxy-2,2,6,6-tetramethylpiperidine) with a degree of oxidation of 18% (p(TMA₁₈-co-TMPMA₈₂))

pTMPMA (2 g, 8.9 mmol) was dissolved in THF (30 mL). The mixture was cooled in an ice bath and a solution of m-chloroperoxybenzoic acid (0.70 g, 3.11 mmol) in THF (15 mL) was added slowly, and the orange mixture was stirred for 1 hour. The polymer was precipitated with 0.5 M NaOH solution (100 mL), redissolved in THF (30 mL), and precipitated in water (500 mL). The polymer was dried under reduced pressure. p(TMA₁₈-co-TMPMA₈₂) was obtained as lightly orange solid in 71% yield.

### C. Preparation of poly(4-methacryloyloxy-2,2,6,6-tetramethylpiperidin-1-oxyl-co-4-methacryloyloxy-2,2,6,6-tetramethylpiperidine) with a degree of oxidation of 84% (p(TMA₈₄-co-TMPMA₁₆))

PTMPMA (2 g, 8.9 mmol) was dissolved in THF (30 mL). The mixture was cooled in an ice bath and a solution of m-chloroperoxybenzoic acid (3.98 g, 17.8 mmol) in THF (15 mL) was added slowly, and the orange mixture was stirred for 1 hour. The polymer was precipitated with 0.5 M NaOH solution (300 mL), redissolved in THF (30 mL), and precipitated in methanol (500 mL). The polymer was dried under reduced pressure. p(TMA₈₄-co-TMPMA₁₆) was obtained as orange solid in 75% yield.

D. Gel Permeation Chromatography (GPC). The molecular weight distribution of each polymer was obtained with gel permeation chromatography. The GPC equipment selected as a Tosoh EcoSEC HLC-8320 mounted with columns: 2× Tosoh Alpha-M Series. The solvent used was dimethylformamide with 14.5 mM of lithium bromide versus PMMA standards. The conditions for the samples injected contained a volume of 40 μL and the concentration of the polymers used was 2 mg/mL. The molecular weight distribution of each copolymer is provided below in Table 2.

High-magnification XPS N1s spectra of p(TMAₓ-co-TMPMA₁₋ₓ) powder with different oxidation degrees corresponding to the entries in Table 2 demonstrated the presence of two distinct nitrogen states of amine and aminoxyl radical. When the relative concentrations of each component representing N—H and N—O· were compared, the trend of increasing N—O· content could be observed with a higher degree of oxidation. The N—O· contents obtained from XPS exhibited lower values compared to UV-Vis-based quantification of N—O·, which may be ascribed to the distribution of more polar N—H groups on the surface caused during the precipitation of polymer sin methanol or water. High-magnification XPS N1s spectra of p(TMA₅₁-co-TMPMA₄₉)-CNT electrode after polarization at positive potentials vs. Ag/AgCl for 1 hour demonstrated the presence of three distinct nitrogen states of amine, aminoxyl radical, and oxoammonium cation.

TABLE 2
Molecular characteristics of copolymers

| | Radical content | Mₙ | M_{w} |
|---|---|---|---|
| | (mol %) | (kg · mol⁻¹) | (kg · mol⁻¹) |
| pTMPMA | 0% | 285.9 | 499.4 |
| p(TMA₁₈-co-TMPMA₈₂) | 18% | 291.7 | 564.0 |
| p(TMA₅₁-co-TMPMA₄₉) | 51% | 84.7 | 290.0 |
| p(TMA₈₄-co-TMPMA₁₆) | 84% | 404.5 | 1191.0 |

### II. Preparation of p(TMAₓ-co-TMPMA₁₋ₓ)-CNT Electrodes

The base substrates were prepared by cutting stainless steel cloth (McMaster-Carr, stainless steel wire cloth, 325×325, wire diameter: 0.0014 inch) into a dimension of 1 cm×2 cm, followed by soldering the steel cloth with copper wire. 80 mg of carbon nanotubes (“CNT”) and 80 mg of p(TMAₓ-co-TMPMA₁₋ₓ) powder were dispersed in 20 mL of acetone by sonicating for 2 hours in icy water. For the coating of the p(TMAₓ-co-TMPMA₁₋ₓ)-CNT, the base substrates were dip-coated into an ink solution of p(TMAₓ-co-TMPMA₁₋ₓ)-CNT, with 3 seconds of contact for each dip, and then drying at room temperature for 30 seconds between each dipping. Electrochemical active area of electrode immersed in electrolyte was 1 cm² (1 cm×1 cm). The final loadings were controlled to be close to 0.6 mg per electrode. Before use, every electrode was activated by carrying out cyclic voltammetry in 0.1 M NaClO₄ in the range of 0-1.2 V (vs. Ag/AgCl) at a scan rate of 10 mV·s⁻¹ for 3 cycles.

### III. Adsorption Studies and Solution Analysis

A. Chemicals and preparation of PFAS solutions. All PFAS chemicals were obtained from Sigma-Aldrich and Santa Cruz Biotechnology. Individual PFAS were dissolved in deionized water to prepare 7.5 or 10 mM stock solution. All stock solutions were stored in a refrigerator at 4° C.

B. Electrochemical adsorption and desorption. A BASi VC-2 voltammetry electrochemical cell with a three-electrode configuration was used for electrochemical tests, with Ag/AgCl as a reference electrode. To investigate the uptake capacity, isotherm, and kinetics of PFOA by p(TMAₓ-co-TMPMA₁₋ₓ)-CNT, 5-mL solutions containing appropriate amounts of PFOA and 20 mM NaCl were used, with Pt being used as a counter electrode. Appropriate potential onto p(TMAₓ-co-TMPMA₁₋ₓ)-CNT electrode was applied as needed for 0.5 or 1 hour for electrosorption. Regeneration of p(TMAₓ-co-TMPMA₁₋ₓ)CNT redox electrode was applied by reversing polarity and applying negative potentials (−0.5, −0.6, −1.0, −1.5 V) for 0.5 or 1 hour in clean 20 mM NaCl solution. A cycling study was carried out using p(TMA₅₁-co-TMPMA₄₉)-CNT, by charging the p(TMA₅₁-co-TMPMA₄₉)-CNT to +1.0 V in the presence of 0.1 mM PFOA and 20 mM NaCl for 30 minutes, followed by applying −1.0 V in clean 20 mM NaCl electrolyte for 1 hour, which was then analyzed for released PFOA.

Boron-doped diamond (“BDD”) electrode was supplied from IKA (Part No. 0040004036) and was used as received. No further modification on BDD was carried out due to BDD's known activity toward PFOA degradation. The wider potential window of BDD, compared to traditional platinum electrode, is demonstrable by cyclic voltammetry. The active electrochemical area of BDD electrode was 1 cm².

For a coupled p(TMA₅₁-co-TMPMA₄₉)-CNT/BDD configuration, adsorption was carried out in the presence of 0.1 mM PFOA and 20 mM NaCl for 30 minutes, followed by reversing the polarity and applying 10 mA·cm⁻² on the BDD electrode in clean 20 mM NaCl electrolyte for 5 hours. All electrochemical studies were performed on a potentio/galvanostat (VSP-300 Multi Channels Potentiostat, Biologic). The PFOA uptake values were reported as the adsorption capacity normalized by the mass of the polymer.

Coulombic efficiency of PFOA uptake by p(TMA₅₁-co-TMPMA₄₉)-CNT electrodes was measured after adsorption in 0.1 mM PFOA and 20 mM NaCl for 0.5 hours at positive potentials. At +0.6 V vs. Ag/AgCl, a Coulombic efficiency higher than 100% indicated that PFOA was bound onto not only redox-mediated oxoammonium sites but also amine moieties in the piperidine rings of TMPMA.

Table 3 below provides a comparison of the sorption of PFOA (Qₘ) on electrodes made of various adsorbent materials.

TABLE 3
Comparison of sorption of PFOA on different adsorbents

| Adsorbent | Qₘ (mg/g) |
|---|---|
| Multi-walled Carbon Nanotubes (“MWCNT”) with | 406 |
| electrochemical assistance | |
| MWCNT without electrochemical assistance | 290 |
| Granular activated carbon | 161 |
| Powder activated carbon | 277 |
| AI400 (anion exchange resin) | 1209 |
| Poly(ethylenimine)-functionalized cellulose microcrystals | 2.3 |
| Anion-exchange resin Amberlite IRA67 | 1167 |
| MIL-101(Cr)-QDMEN - Anion-Exchange Metal-Organic | 753 |
| Frameworks | |
| Quaternized cotton | 1283 |
| pTMPMA-CNT at +1.0 V | 1717 |
| p(TMA₅₁-co-TMPMA₄₉)-CNT at +1.0 V | 1064 |
| p(TMA₅₁-co-TMPMA₄₉)-CNT at open circuit | 840-970 |

Without being bound by theory, during adsorption, N—H sites of piperidine in TMPMA and redox-active oxoammonium in oxidized TMA units work in a synergistic way for enhanced electrostatic attraction of PFOA. During regeneration, redox-mediated charge repulsion enhanced by aminoxyl/oxoammonium couple facilitates electrochemically-controlled release. The ratio between TMA and TMPMA may also tune hydrophobicity, to achieve an optimal degree for PFOA binding and reversible release.

### C. Flow By-Cell Assembly.

Alternatively, a flow cell assembly was composed of a top flowing (“TF”) acrylic base, TF electrode backing gasket, p(TMA-co-TMPMA)-CNT electrode, 1/16″ middle gasket, 4 cm×4 cm plastic mesh, Ti electrode, which could be switched to a Pt-coated/Ti electrode, bottom flowing (“BF”) backing electrode backing gasket, and BF acrylic base. The flow cell was tightened with 8 M3 nuts and bolts in an aleatory fashion (1, 5, 2, 6, 3, 7, 4, 8) to provide stability and prevent leaking by adjusting to a proper seal. This seal was rapidly tested by passing an initial solvent solution without applying any potential and measuring the volume in versus the volume out for 1 minute.

The p(TMA-co-TMPMA)-CNT electrode had an active area of 4 cm×4 cm. A non-conductive tape was placed around the corners of the Ti- or Pt-coated/Ti plate to obtain a precise coating area of 4 cm×4 cm. The polymer solution was then dropped cast, and a total volume of 800 μL was injected onto the surface. The solution was dried rapidly in air, and to ensure dryness, forced air was applied onto the surface to enhance the drying. Before experimentation, the electrode was pre-treated by activating the electrode with cyclic voltammetry in 0.1 M NaClO₄ in the range of 0-1.2 V (vs. Ag/AgCl) at a scan rate of 10 mV·s⁻¹ for three cycles to then fully reduce for 3 minutes at 0.0 V.

For the flow cell, experimental analysis on two electrodes was compared: one electrode containing bare Ti and a Pt-coated/Ti plate. The Pt-coated Ti electrode was sputter coated (3×3 in.) through magnetron sputtering (AJA ORION 3 sputter system with ST20 ORION magnetron sputter gun). The base pressure was 2.5·10⁻⁶ Torr, and argon was used at a process pressure of 3.4 mTorr. Sputtering took place at room temperature, with direct current and 80 W power, approximately 15 rpm sample rotation, 1 minute pre-sputtering. The recorded sputtering rate was 9.6-10.4 Å/s. The Pt thickness measured by the instrument's quartz crystal microbalance was 251.0 nm.

To start the experimentation, the stock solution, composed of 0.1 mM HFPO-DA and 20 mM NaCl or 0.1 mM PFO and 20 mM NaCl, was placed on a magnetic stirring plate. A suction side tube, connected to the Longer peristaltic pump, was inserted in the stock solution, and the discharge side tube was connected to the bottom flowing inlet of the flow cell. On the other side of the flow cell, a tube was attached to the output flowing outlet of the flow to collect samples. The electrolyte flowed from the bottom of the Ti side to flow out from the top on the p(TMA-co-TMPMA)-CNT side. The flow rate of the peristaltic pump was calculated and set to be 1.0 mL/min.

Typical experimental parameters were set as follows: 30 minutes adsorption—chronopotentiometry (2 mA); 10 minute mid-rinse—open circuit (0 A); 30 minutes desorption—chronopotentiometry (−2.0 mA). During the experiment, the sample collection was set for one sample collection every five minutes of the experimental run. In addition, a 5-mL stock solution was taken directly before and directly after the experiment.

Prior to electrochemical HFPO-DA adsorption, 0.1 mM HFPO_DA solution was cycled through the flow cell apparatus (1 mL/mIN) at open circuit for 24 hours to allow the system to equilibrate. Electrochemical HFPO-DA adsorption was then carried out via application of a constant +2 mA current for 30 minutes, at which 109 mg/g adsorbent was achieved with an energy consumption of 1 KJ/g adsorbent (2 KJ/g copolymer). Linear uptake profiles indicate that complete saturation of the working electrode may not occur within 30 minutes, and adsorption equilibrium of HFPO-DA may be higher given more time.

Following adsorption, the flow cell inlet was changed to a pristine solution including no HFPO-DA and allowed to flush for 10 minutes at open circuit. During the solution change-over, very little HFPO-DA was observed to be released into the pristine solution, and uptake was equilibrated to 100 mg/g, indicating little to no concentration equilibrium-based release mechanism. After the 10-minute flush, a constant current of −2 mA was applied, releasing bound HFPO-DA into a pristine following solution. The system demonstrated a regeneration efficiency of 93% after 30 minutes, with 1.80 KJ/g adsorbent (3.5 KJ/g copolymer) energy consumed. The flow cell results illustrate the potential of the p(TMA-co-TMPMA) electrochemical adsorption platform for continuous adsorption applications in HFPO-DA remediation, and highlights the importance of potential in the HFPO-DA removal process, in which the bound HFPO-DA was only released once a reducing current was applied.

Without being bound by theory, once a negative potential is applied, the N═O⁺ oxoammonium sites were reduced to their original aminoxyl radical (N—O·) state, promoting the release of HFPO-DA molecule by electrostatic repulsion. Different release/regeneration potentials were tested, ranging from −1.5 to 0.0 V vs. Ag/AgCl for 1 hour. The results indicated that decreasing potentials led to higher release of HFPO-DA. For a representative voltage for tests, −1 V vs. Ag/AgCl was selected. Applying a reductive potential was shown to enhance desorption compared to the open circuit, with a release of HFPO-DA of greater than 80% after 1 hour of electrochemical operation.

Cyclability tests were performed for 5 cycles of electrosorption and electrochemical release: during electrosorption, a potential of 0.8 V vs. Ag/AgCl was applied for 30 minutes, with a solution of 5 mL of 0.1 mM HFPO-DA and 20 mM NaCl for adsorption; for desorption, a −1.0 V vs. Ag/AgCl potential was applied, and the system was reduced for 1 hour into a 20 mM NaCl solution. The adsorption capacity of the system was maintained, but the regeneration efficiency (the amount of HFPO-DA recovered during release relative to the amount adsorbed) decreased considerably, and after four cycles, only up to 20% regeneration efficiency was observed. It was hypothesized that partial degradation of HFPO-DA may have occurred during reductive regeneration.

A high-resolution mass spectroscopy (“HR-MS”) analysis was performed on a solution that mimics a typical release concentration after an adsorption cycle, which is a concentration of 0.024 mM HFPO-DA+20 mM NaCl, and the mass spectra were analyzed after applying −1.0 V vs. Ag/AgCl for one hour to evaluate the amount of any electrochemically-mediated degradation. The HR-MS peak analysis may indicate that HFPO-DA degradation may occur at the carboxylate group of HFPO-DA, and through cleavage of the ether bond. The results support the hypothesis that HFPO-DA may be degrading under reductive potentials and treatment times for regeneration, leading to low regeneration efficiency for separation, yet the preserved adsorption capacity.

BDD served as an efficient candidate for defluorination of PFAS because BDD may generate hydroxyl radicals under high overpotentials that are able to cleave the C—F bond of the PFAS, while the BDD also displays significant chemical and electrochemical stability. An integrated electrochemical system for first electrosorbing HFPO-DA and later simultaneously defluorinating the PFAS during the release step at the counter electrode was evaluated, by first adsorbing on p(TMA-co-TMPMA) for 30 minutes by applying 0.8 V vs. Ag/Cl, and then reversing the polarity and desorbing from the p(TMA-co-TMPMA) electrode, simultaneously defluorinating with the help of BDD, by applying 10 mA/cm² under continuous stirring (500 rpm). Results of the evaluation indicated gradual defluorination behavior with time, and after 24 hours of operation at 10 mA/cm², the system was able to release adsorbed HFPO-DA completely, and achieve 100% defluorination efficiency.

D. LC-MS Analysis for PFAS quantification. Concentrations of anionic PFAS compounds were measured using Waters Synapt G2Si with Waters Acquity H-class UPLC system, and the MassLynx™ 4.1 workstation was utilized for following data acquisition and processing. Aquity UPLC BEH C18 (1.7 μm) was chosen as the chromatographic column. The temperature of the column was kept at 40° C. Mobile phase system comprises 5 mM NH₄OAc aqueous solution (A) and acetonitrile (B), with the flow velocity of 0.4 mL·min⁻¹. Injection volume of the sample was 0.1 or 1 μL for negative ionization (ESI−) mode. Gradient elution as follows: 0-3 minutes: 30-65% B; 3-4 minutes: 65% B; 4-5 minutes: 65-100% B; 5-8 minutes: 100% B; 8.1 minutes: 30% B; 10 minutes: 30% B.

Injection volume for each PFAS differed depending on the compound. Longer chain PFAS, such as PFOA, were rapidly detected and would require a smaller injection volume and lower calibration curve concentrations. Table 4 below indicates the summary for each LC/MS standard and injection volume.

TABLE 4
LC/MS calibration curve standards
concentration and injection volumes

| Compound | Calibration Curve (μM) | Injection Volume (μL) |
|---|---|---|
| PFOA | 0-5 | 0.5 |
| HFPO-DA | 0-25 | 10 |
| PFBS | 0-25 | 10 |
| PFBA | 0-25 | 10 |
| PFHpA | 0-5 | 0.5 |

E. Fluoride analysis using ion chromatography. All the chromatographic separations were carried out on a Thermo Fisher Dionex 2100 ion chromatography system equipped with an EGC III KOH eluent generator, conductivity cell, a pump, a Chromeleon v6.8 workstation, and connected to an AS-AP autosampler. A Thermo Scientific ADRS 600 4 mm suppressor was used to lower the background eluent. A Dionex IonPac AS18 (4×250 mm) anion exchange column with an in-line AG18 guard (4×50 mm) was used to separate fluoride from other species. Samples were prepped for IC by filtering through a 0.22 μm PTFE membrane syringe filter (Biomed Scientific) to prevent sample contaminants from eluting into the anion exchange column. A series of standard solutions were prepared from an IC multi-element standard I (certipur, USA) and diluted using deionized water produced by a Milli-Q system.

### IV. Material Characterization

NMR spectra were record on Varian Unity Inova 40 MHz spectrometer equipped with a Nalorac QUAD probe. UV-Vis absorbance was obtained first by preparing 8 mg·mL⁻¹ solutions of p(TMAₓ-co-TMPMA₁₋ₓ) dissolved in chloroform and measuring with UV-Vis spectrophotomer (Cary 60. Agilent). Contact angle analysis was carried out with a Ramé-Hart Model 250 Standard Goniometer. DROPimage Advanced software was used for drop shape analyzer. Fourier transform infrared (FT-IR) spectroscopy was measured on the Thermo Nicolet Nexus 670 FT-IR spectrophotometer. The surface images and elemental mapping images (EDS) of p(TMAₓ-co-TMPMA₁₋ₓ)-CNT electrodes were obtained using a scanning electron microscope (SEM; Hitachi S-4700) operated at an accelerating voltage of 10 kV, equipped with energy dispersive X-ray spectroscopy (“EDS”; iXRF) with the accelerating voltage of 15 kV. The chemical states of nitrogen and fluoride on the electrodes were characterized using X-ray photoelectron spectroscopy (“XPS”; Kratos Axis ULTRA) with monochromatic AI Kα X-ray source (210 W). The XPS results were analyzed using CASA XPS software. The spectra were calibrated with the C 1s peak (284.8 eV). The spectra were fitted into their components following subtraction of a Shirley background from the region of interest. Electron paramagnetic resonance (“EPR”) spectroscopy was used to confirm the radical behavior of p(TMAₓ-co-TMPMA₁₋ₓ). The solid analysis was performed in a 3-mm diameter quartz EPR tube and the sample was diluted with high-purity (99.999%) KNO₃ in a 1:9 ratio. The Bruker EMXPlus spectrometer was used with ant X-band frequency of 9.8 GHz. The frequency was produced by a Bruker ER4119HS high sensitivity resonator.

The effectiveness of an electrochemically-mediated system for the electrosorption of examples of PFAS, such as HFPO-DA, using an example of a redox copolymer, including p(TMA-co-TMPMA), was demonstrated. The electrochemical removal performance of the redox copolymers was evaluated across a range of PFAS concentrations in different water matrices, pH values, and ionic strengths, proving the effectiveness of these tailored functional electrodes for the adsorption of the PFAS. In particular, the enhancement of adsorption kinetics under electrochemical conditions was highlighted, demonstrating >95% PFAS removal in 9 minutes versus 30 minutes for >95% removal with open circuit. At different pH values, the adsorption mechanism may be ascribed to varying degrees of hydrophobic affinity or electrostatic attraction, depending on the protonation characteristics of both the electrode and the PFAS. The redox electrodes were shown to release PFAS and re-adsorb for sequential cycles without significant drops in uptake capacity. The potential integration of the redox electrodes with defluorination systems such as BDD for tandem removal and remediation of PFAS for up to 100% defluorination after 24 hours was demonstrated. The redox electrodes were translated to a flow cell system, confirming that the electrosorption and release of PFAS could be modulated under continuous electrosorption conditions.

Although the present disclosure has been described with reference to examples and the accompanying drawings, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to a reduction-oxidation (“redox”) copolymer for electrochemically-assisted electrosorption and release of an organic micropollutant from a contaminated water source, the redox copolymer comprising: a neutral or cationic redox compound; and a cationic compound.

A second aspect relates to the redox copolymer of aspect 1, wherein the redox compound is selected from the group consisting of: a nitroxide, a ferrocene, a cobaltocene, and a viologen.

A third aspect relates to the redox copolymer of any preceding aspect, wherein the cationic compound is selected from the group consisting: an amine, an ammonium, a guanidinium, a phosphonium, and a tertiary sulfonium.

A fourth aspect relates to the redox copolymer of any preceding aspect, wherein the redox compound is a nitroxide selected from the group consisting of:

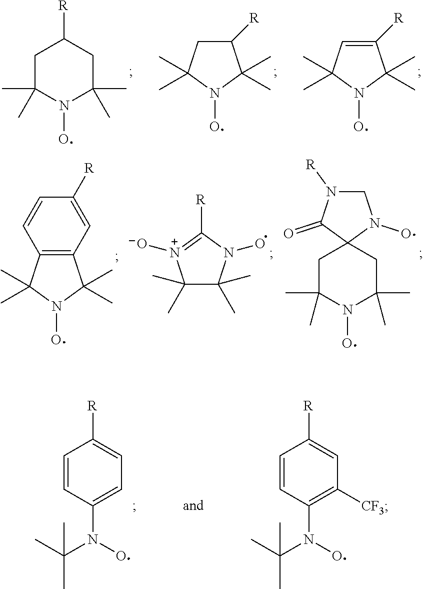

wherein R is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

A fifth aspect relates to the redox copolymer of any preceding aspect, wherein the cationic compound is an amine or an ammonium selected from the group consisting of:

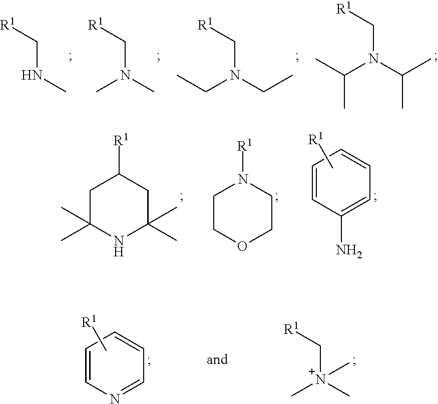

wherein R¹ is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R¹ is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

A sixth aspect relates to the redox copolymer of any preceding aspect, wherein the redox compound is

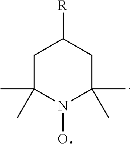

A seventh aspect relates to the redox copolymer of any preceding aspect, wherein the cationic compound is

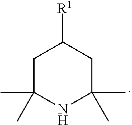

An eighth aspect relates to the redox copolymer of any preceding aspect, wherein the organic micropollutant is a perfluoroalkyl or polyfluoroalkyl substance.

A ninth aspect relates to the redox copolymer of any preceding aspect, wherein the organic micropollutant is a compound of formula (I):

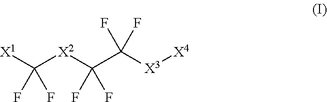

wherein: X¹ is chloro or fluoro; X² is a bond, O, O—CF₂, or CₙF₂ₙ wherein n is an integer from 1 to 10; X³ is a bond, ethylene, SO₂—N(CH₃)—CH₂, SO₂—N(CH₂CH₃)—CH₂, O—CF(CF₃), O—CF₂—CHF, or O—CF₂—CF₂; and X⁴ is CO₂H, SO₃H, or SO₂NH₂.

A tenth aspect relates to the redox copolymer of any preceding aspect, wherein the organic micropollutant comprises a carboxylate moiety, a sulfonate moiety, or a phosphate moiety.

An eleventh aspect relates to the redox copolymer of any preceding aspect, wherein the organic micropollutant is selected from the group consisting of: perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, N-methylperfluorooctane sulfonamidoacetic acid, N-ethylperfluorooctane sulfonamidoacetic acid, perfluorooctanesulfonamide, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid, 4:2 fluorotelomer sulfonic acid; 6:2 fluorotelomer sulfonic acid, 8:2 fluorotelomer sulfonic acid, 11-chloroeicosafluoro-3-oxaundecane-1-sulfonic acid, 9-chlorohexadecafluoro-3-oxanone-1-sulfonic acid, 4,8-dioxa-3H-perfluorononanoic acid, and hexafluoropropylene oxide dimer acid.

A twelfth aspect relates to an electrochemical system, comprising: a first electrode, comprising a conductive solid substrate and a reduction-oxidation (“redox”) copolymer immobilized to the conductive solid substrate; a second electrode spaced apart from the first electrode; and a vessel in which the first electrode and the second electrode are partially submerged, the vessel comprising a fluid comprising a target molecule; wherein the first electrode is configured to be tunable in redox activity, hydrophobicity, and/or binding affinity, and configured to be selective toward the target molecule.

A thirteenth aspect relates to the electrochemical system of aspect 12, wherein the redox copolymer is configured to selectively bind to a negatively charged functional group of a target molecule when the redox copolymer is in a neutral or cationic state.

A fourteenth aspect relates to the electrochemical system of aspect 12 or 13, wherein the redox copolymer comprises a redox active moiety and a second moiety; and wherein the second moiety is configured to be positively charged at a pH at which the electrochemical system is operated.

A fifteenth aspect relates to the electrochemical system of any one of aspects 12 to 14, wherein the redox copolymer comprises a redox active moiety selected from the group consisting of: a nitroxide, a ferrocene, a cobaltocene, and a viologen.

A sixteenth aspect relates to the electrochemical system of any one of aspects 12 to 15, wherein the redox copolymer comprises a second moiety selected from the group consisting of: an amine, an ammonium, a guanidinium, a phosphonium, and a tertiary sulfonium.

A seventeenth aspect relates to the electrochemical system of any one of aspects 12 to 16, wherein the redox copolymer comprises a nitroxide moiety selected from the group consisting of:

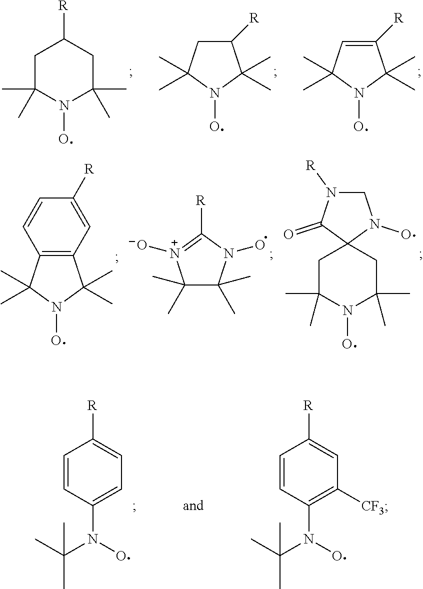

wherein R is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₅)cycloalkylCO₂—, (C₂-C₁₆)alkenylCO₂—, or (C₂-C₁₆)alkynylCO₂— group; and wherein when R is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

An eighteenth aspect relates to the electrochemical system of any one of aspects 12 to 17, wherein the redox copolymer comprises a second moiety that is an amine or an ammonium selected from the group consisting of:

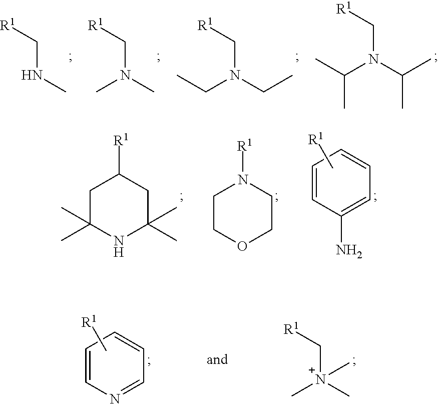

wherein R¹ is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R¹ is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

A nineteenth aspect relates to the electrochemical system of any one of aspects 12 to 18, wherein the redox copolymer comprises a nitroxide moiety that is

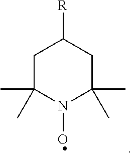

A twentieth aspect relates to the electrochemical system of any one of aspects 12 to 19, wherein the redox copolymer comprises a second moiety that is

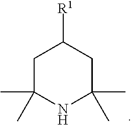

A twenty-first aspect relates to the electrochemical system of any one of aspects 12 to 20, wherein the target molecule comprises a carboxylate moiety, a sulfonate moiety, or a phosphate moiety.

A twenty-second aspect relates to the electrochemical system of any one of aspects 12 to 21, wherein the target molecule is a perfluoroalkyl or polyfluoroalkyl substance.

A twenty-third aspect relates to the electrochemical system of any one of aspects 12 to 22, wherein the target molecule is a compound of formula (I):

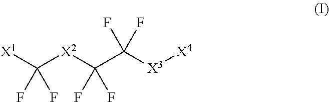

wherein: X¹ is chloro or fluoro; X² is a bond, O, O—CF₂, or CₙF₂ₙ wherein n is an integer from 1 to 10; X³ is a bond, ethylene, SO₂—N(CH₃)—CH₂, SO₂—N(CH₂CH₃)—CH₂, O—CF(CF₃), O—CF₂—CHF, or O—CF₂—CF₂; and X⁴ is CO₂H, SO₃H, or SO₂NH₂.

A twenty-fourth aspect relates to the electrochemical system of any one of aspects 12 to 23, wherein the target molecule comprises a carboxylate moiety, a sulfonate moiety, or a phosphate moiety.

A twenty-fifth aspect relates to the electrochemical system of any one of aspects 12 to 24, wherein the target molecule is selected from the group consisting of: perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, N-methylperfluorooctane sulfonamidoacetic acid, N-ethylperfluorooctane sulfonamidoacetic acid, perfluorooctanesulfonamide, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid, 4:2 fluorotelomer sulfonic acid; 6:2 fluorotelomer sulfonic acid, 8:2 fluorotelomer sulfonic acid, 11-chlorocicosafluoro-3-oxaundecane-1-sulfonic acid, 9-chlorohexadecafluoro-3-oxanone-1-sulfonic acid, 4,8-dioxa-3H-perfluorononanoic acid, and hexafluoropropylene oxide dimer acid.

A twenty-sixth aspect relates to the electrochemical system of any one of aspects 12 to 25, wherein the second electrode is configured to be a counter-electrode of the first electrode; and wherein the second electrode is configured to catalyze degradation of the target molecule during the operation of the electrochemical system.

A twenty-seventh aspect relates to the electrochemical system of any one of aspects 12 to 26, wherein the second electrode is configured to be chemically inert in aqueous media and configured to have high overpotential for water-splitting reactions.

A twenty-eighth aspect relates to the electrochemical system of any one of aspects 12 to 27, wherein the second electrode comprises a material selected from the group consisting of oxides of tin, lead, and/or titanium; platinum; and boron-doped diamond.

A twenty-ninth aspect relates to the electrochemical system of any one of aspects 12 to 28, wherein the conductive solid substrate comprises graphite, carbon nanotube(s), and mixtures thereof.

A thirtieth aspect relates to the electrochemical system of any one of aspects 12 to 29, wherein the first electrode is coated onto a porous support selected from the group consisting of porous metal and porous carbon.

A thirty-first aspect relates to a method of separating and degrading target molecules in tandem from a fluid, comprising: placing in the fluid a first electrode and a second electrode spaced apart from the first electrode, the first electrode comprising a solid substrate and a redox copolymer immobilized to the solid substrate, and the fluid source comprising the target molecules; applying an electrical potential across the first electrode and the second electrode such that the redox copolymer transforms to an oxidized state and selectively binds to a target electron-donating functional group of the target molecules to provide bound target molecules; and reversing the applied potential such that the bound target molecules are released from the first electrode and degraded on a surface of the second electrode.

A thirty-second aspect relates to the method of aspect 31, wherein the reversing comprises catalyzing oxidative or reductive degradation of the released target molecules on the surface of the second electrode.

A thirty-third aspect relates to the method of aspect 31 or 32, wherein the second electrode comprises a material selected from the group consisting of oxides of tin, lead, and/or titanium; platinum; and boron-doped diamond.

A thirty-fourth aspect relates to the method of any one of aspects 31 to 33, wherein the target molecules are selected from the group consisting of a perfluoroalkyl compound, a polyfluoroalkyl compound, a pharmaceutical compound, a personal healthcare product, a detergent, a pesticide, a herbicide, and/or an organic wastewater contaminant.

A thirty-fifth aspect relates to the method of any one of aspects 31 to 34, wherein the redox copolymer comprises a redox active moiety and a second moiety; and wherein the second moiety is positively charged.

A thirty-sixth aspect relates to the method of any one of aspects 31 to 35, wherein the redox active moiety is selected from the group consisting of: a nitroxide, a ferrocene, a cobaltocene, and a viologen.

A thirty-seventh aspect relates to the method of any one of aspects 31 to 36, wherein the second moiety is selected from the group consisting of: an amine, an ammonium, a guanidinium, a phosphonium, and a tertiary sulfonium.

A thirty-eighth aspect relates to the method of any one of aspects 31 to 37, wherein the redox copolymer comprises a nitroxide moiety selected from the group consisting of:

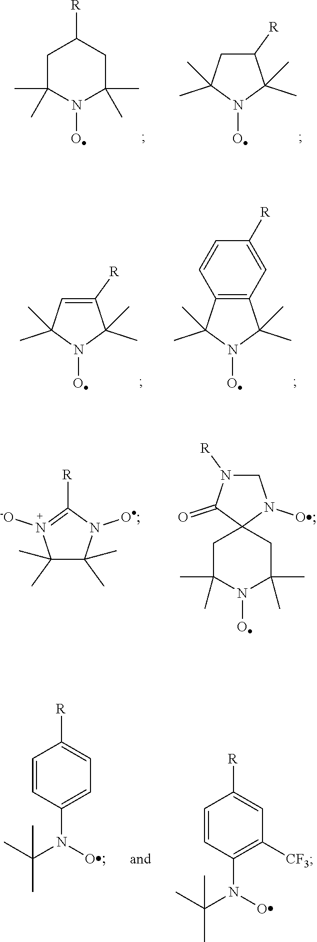

wherein R is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

A thirty-ninth aspect relates to the method of any one of aspects 31 to 38, wherein the second moiety is an amine or an ammonium selected from the group consisting of:

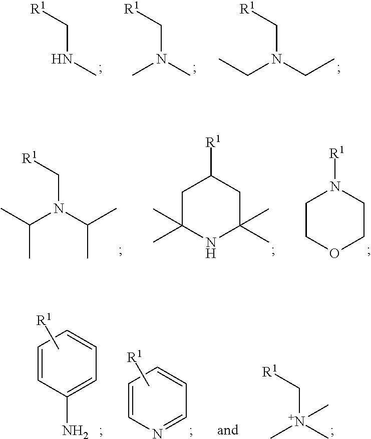

wherein R¹ is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R¹ is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

A fortieth aspect relates to the method of any one of aspects 31 to 39, wherein the redox moiety comprises a nitroxide moiety that is

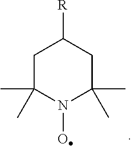

A forty-first aspect relates to the method of any one of aspects 31 to 40, wherein the second moiety that is

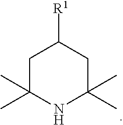

A forty-second aspect relates to the method of any one of aspects 31 to 41, wherein the target molecules comprise a carboxylate moiety, a sulfonate moiety, or a phosphate moiety.

A forty-third aspect relates to the method of any one of aspects 31 to 42, wherein the target molecules are molecules of a perfluoroalkyl or polyfluoroalkyl substance.

A forty-fourth aspect relates to the method of any one of aspects 31 to 43, wherein the target molecules are molecules of a compound of formula (I):

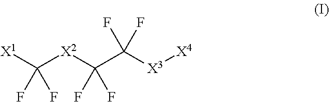

wherein: X¹ is chloro or fluoro; X² is a bond, O, O—CF₂, or CₙF₂ₙ wherein n is an integer from 1 to 10; X³ is a bond, ethylene, SO₂—N(CH₃)—CH₂, SO₂—N(CH₂CH₃)—CH₂, O—CF(CF₃), O—CF₂—CHF, or O—CF₂—CF₂; and X⁴ is CO₂H, SO₃H, or SO₂NH₂.

A forty-fifth aspect relates to the method of any one of aspects 31 to 44, wherein the target molecules comprise a carboxylate moiety, a sulfonate moiety, or a phosphate moiety.

A forty-sixth aspect relates to the method of any one of aspects 31 to 45, wherein the target molecules are molecules of a compound selected from the group consisting of: perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, N-methylperfluorooctane sulfonamidoacetic acid, N-ethylperfluorooctane sulfonamidoacetic acid, perfluorooctanesulfonamide, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid, 4:2 fluorotelomer sulfonic acid; 6:2 fluorotelomer sulfonic acid, 8:2 fluorotelomer sulfonic acid, 11-chlorocicosafluoro-3-oxaundecane-1-sulfonic acid, 9-chlorohexadecafluoro-3-oxanone-1-sulfonic acid, 4,8-dioxa-3H-perfluorononanoic acid, and hexafluoropropylene oxide dimer acid.

A forty-seventh aspect relates to the method of any one of aspects 31 to 46, wherein the second electrode is a counter-electrode of the first electrode.

A forty-eighth aspect relates to the method of any one of aspects 31 to 47, wherein the second electrode is configured to be chemically inert in aqueous media and configured to have high overpotential for water-splitting reactions.

A forty-ninth aspect relates to the method of any one of aspects 31 to 48, wherein the fluid is a body of surface water, waste water, or contaminated water.

A fiftieth aspect relates to a system for separating and degrading target molecules in tandem from a fluid, the system comprising: a first electrode, comprising a conductive solid substrate and a reduction-oxidation (“redox”) copolymer immobilized to the conductive solid substrate; a second electrode spaced apart from the first electrode; a processor electrically connected to a power source, the power source electrically connected to the first electrode and the second electrode; and a vessel comprising a fluid, the first electrode and the second electrode partially submerged in the fluid, the fluid comprising the target molecules; wherein the first electrode is configured to be tunable in redox activity, hydrophobicity, and binding affinity, and configured to be selective toward the target molecules; and wherein the processor is configured to: apply an electrical potential across the first electrode and the second electrode such that the redox copolymer transforms to an oxidized state and selective binds to a target electron-donating functional group of the target molecules to provide bound target molecules; and reverse the applied potential such that the bound target molecules are released from the first electrode and degraded on a surface of the second electrode.

A fifty-first aspect relates to the system of aspect 50, wherein the processor is further configured to catalyze oxidative or reductive degradation of released target molecules on the surface of the second electrode during operation of the system.

A fifty-second aspect relates to the system of aspect 50 or 51, wherein the second electrode comprises a material selected from the group consisting of: oxides of tin, lead, and/or titanium; platinum; and boron-doped diamond.

A fifty-third aspect relates to the system of any one of aspects 50 to 52, wherein the target molecules are selected from the group consisting of a perfluoroalkyl compound, a polyfluoroalkyl compound, a pharmaceutical compound, a personal healthcare product, a detergent, a pesticide, a herbicide, and/or an organic wastewater contaminant.

A fifty-fourth aspect relates to the system of any one of aspects 50 to 53, wherein the redox copolymer comprises a redox active moiety and a second moiety; and wherein the second moiety is positively charged.

A fifty-fifth aspect relates to the system of any one of aspects 50 to 54, wherein the redox active moiety is selected from the group consisting of: a nitroxide, a ferrocene, a cobaltocene, and a viologen.

A fifty-sixth aspect relates to the system of any one of aspects 50 to 55, wherein the second moiety is selected from the group consisting of: an amine, an ammonium, a guanidinium, a phosphonium, and a tertiary sulfonium.

A fifty-seventh aspect relates to the system of any one of aspects 50 to 56, wherein the redox copolymer comprises a nitroxide moiety selected from the group consisting of:

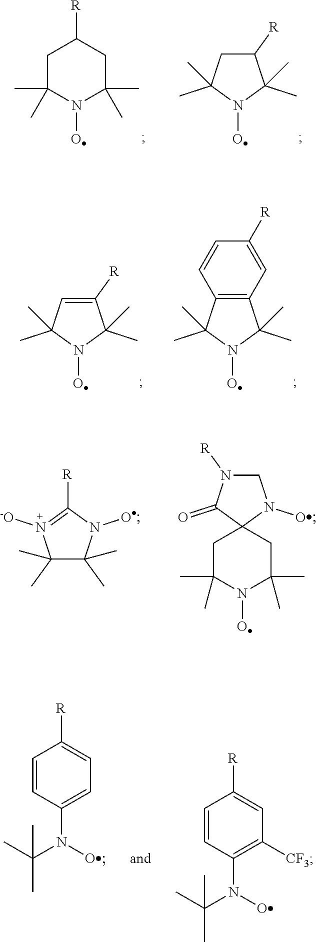

wherein R is hydrogen or a branched or straight-chain, substituted or unsubstituted —(C₁-C₁₆)alkyl, —(C₃-C₈)cycloalkyl, (C₂-C₁₆)alkenyl, (C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

A fifty-eighth aspect relates to the system of any one of aspects 50 to 57, wherein the second moiety is an amine or an ammonium selected from the group consisting of:

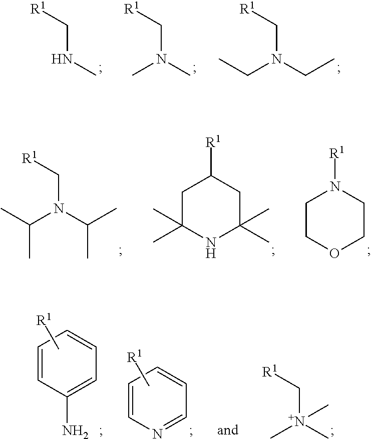

wherein R¹ is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and wherein when R¹ is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

A fifty-ninth aspect relates to the system of any one of aspects 50 to 58, wherein the redox moiety comprises a nitroxide moiety that is

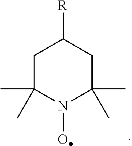

A sixtieth aspect relates to the system of any one of aspects 50 to 59, wherein the second moiety that is

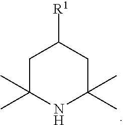

A sixty-first aspect relates to the system of any one of aspects 50 to 60, wherein the target molecules comprise a carboxylate moiety, a sulfonate moiety, or a phosphate moiety.

A sixty-second aspect relates to the system of any one of aspects 50 to 61, wherein the target molecules are molecules of a perfluoroalkyl or polyfluoroalkyl substance.

A sixty-third aspect relates to the system of any one of aspects 50 to 62, wherein the target molecules are molecules of a compound of formula (I):

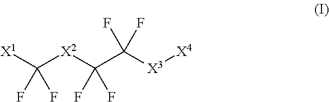

wherein: X¹ is chloro or fluoro; X² is a bond, O, O—CF₂, or CₙF₂ₙ wherein n is an integer from 1 to 10; X³ is a bond, ethylene, SO₂—N(CH₃)—CH₂, SO₂—N(CH₂CH₃)—CH₂, O—CF(CF₃), O—CF₂—CHF, or O—CF₂—CF₂; and X⁴ is CO₂H, SO₃H, or SO₂NH₂.

A sixty-fourth aspect relates to the system of any one of aspects 50 to 63, wherein the target molecules comprise a carboxylate moiety, a sulfonate moiety, or a phosphate moiety.

A sixth-fifth aspect relates to the system of any one of aspects 50 to 64, wherein the target molecules are molecules of a compound selected from the group consisting of: perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, N-methylperfluorooctane sulfonamidoacetic acid, N-ethylperfluorooctane sulfonamidoacetic acid, perfluorooctanesulfonamide, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, perfluorodecanesulfonic acid, 4:2 fluorotelomer sulfonic acid; 6:2 fluorotelomer sulfonic acid, 8:2 fluorotelomer sulfonic acid, 11-chloroeicosafluoro-3-oxaundecane-1-sulfonic acid, 9-chlorohexadecafluoro-3-oxanone-1-sulfonic acid, 4,8-dioxa-3H-perfluorononanoic acid, and hexafluoropropylene oxide dimer acid.

A sixty-sixth aspect relates to the system of any one of aspects 50 to 65, wherein the second electrode is a counter-electrode of the first electrode.

A sixty-seventh aspect relates to the system of any one of aspects 50 to 66, wherein the second electrode is configured to be chemically inert in aqueous media and configured to have high overpotential for water-splitting reactions.

A sixty-eighth aspect relates to the system of any one of aspects 50 to 67, wherein the fluid is a body of surface water, waste water, or contaminated water.

In addition to the features mentioned in each of the independent aspects enumerated above, some examples may show, alone or in combination, the optional features mentioned in the dependent aspects and/or as disclosed in the description above and shown in the figures.

1. A reduction-oxidation (“redox”) copolymer for electrochemically-assisted electrosorption and release of an organic micropollutant from a contaminated water source, the redox copolymer comprising:
a neutral or cationic redox compound; and
a cationic compound.

2. The redox copolymer of claim 1, wherein the redox compound is selected from the group consisting of: a nitroxide, a ferrocene, a cobaltocene, and a viologen.

3. The redox copolymer of claim 1, wherein the cationic compound is selected from the group consisting of: an amine, an ammonium, a guanidinium, a phosphonium, and a tertiary sulfonium.

4. The redox copolymer of claim 1, wherein the redox compound is a nitroxide selected from the group consisting of: 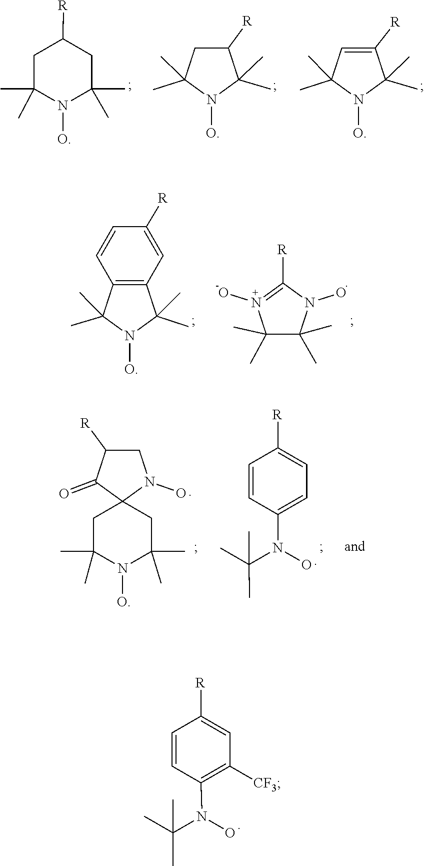
wherein R is hydrogen or a branched or straight-chain, substituted or unsubstituted —(C₁-C₁₆)alkyl, —(C₃-C₅)cycloalkyl, —(C₂-C₁₆)alkenyl, —(C₂-C₁₆)alkynyl, (C₁-C₁₆)alkylCO₂—, (C₃-C₅)cycloalkylCO₂—, (C₂-C₁₆)alkenylCO₂—, or (C₂-C₁₆)alkynylCO₂— group; and
wherein when R is substituted with one or more substituents, the one or more substituents are independently selected from the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

5. The redox copolymer of claim 1, wherein the cationic compound is an amine or an ammonium selected from the group consisting of: 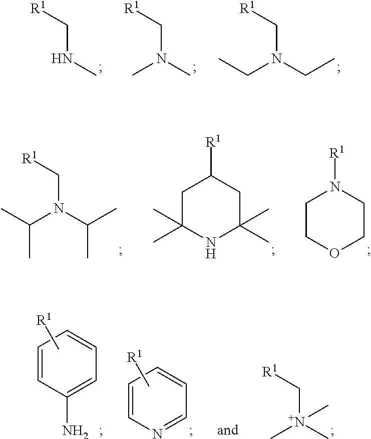
wherein R¹ is hydrogen or a branched or straight-chain, substituted or unsubstituted —(C₁-C₁₆)alkyl, —(C₃-C₈)cycloalkyl, —(C₂-C₁₆)alkenyl, —(C₂-C₁₆)alkynyl, (C₁-C₁₆)alkylCO₂—, (C₃-C₈)cycloalkylCO₂—, (C₂-C₁₆)alkenylCO₂—, or (C₂-C₁₆)alkynylCO₂— group; and
wherein when R¹ is substituted with one or more substituents, the one or more substituents are independently selected form the group consisting of (C₁-C₁₆)alkoxy, (C₁-C₁₆)alkylcarboxy, N—((C₁-C₁₆)alkyl)amido, N,N-di(C₁-C₁₆)alkylamino, and halo.

6-7. (canceled)

8. The redox copolymer of claim 1, wherein the organic micropollutant is a perfluoroalkyl or polyfluoroalkyl substance.

9. The redox copolymer of claim 1, wherein the organic micropollutant is a compound of formula (I): 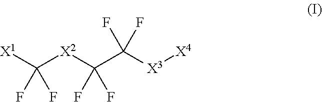
wherein:
X¹ is chloro or fluoro;
X² is a bond, O, O—CF₂, or CₙF₂ₙ wherein n is an integer from 1 to 10;
X³ is a bond, ethylene, SO₂—N(CH₃)—CH₂, SO₂—N(CH₂CH₃)—CH₂, O—CF(CF₃), O—CF₂—CHF, or O—CF₂—CF₂; and
X⁴ is CO₂H, SO₃H, or SO₂NH₂.

10-11. (canceled)

12. An electrochemical system, comprising:
a first electrode, comprising a conductive solid substrate and a reduction-oxidation (“redox”) copolymer immobilized to the conductive solid substrate;
a second electrode spaced apart from the first electrode; and
a vessel in which the first electrode and the second electrode are partially submerged, the vessel comprising a fluid comprising a target molecule;
wherein the first electrode is configured to be tunable in redox activity, hydrophobicity, and/or binding affinity, and configured to be selective toward the target molecule.

13. The electrochemical system of claim 12, wherein the redox copolymer is configured to selectively bind to a negatively charged functional group of the target molecule when the redox copolymer is in a neutral or cationic state.

14. The electrochemical system of claim 12,
wherein the redox copolymer comprises a redox active moiety and a second moiety; and
wherein the second moiety is configured to be positively charged at a pH at which the electrochemical system is operated.

15. The electrochemical system of claim 12, the system comprising a processor electrically connected to a power source, the power source electrically connected to the first electrode and the second electrode; and
wherein the processor is configured to:
apply an electrical potential across the first electrode and the second electrode such that the redox copolymer transforms to an oxidized state and selective binds to a target electron-donating functional group of the target molecules to provide bound target molecules; and
reverse the applied potential such that the bound target molecules are released from the first electrode and degraded on a surface of the second electrode.

16. The electrochemical system of claim 15, wherein the processor is further configured to catalyze oxidative or reductive degradation of released target molecules on the surface of the second electrode during operation of the system.

17-25. (canceled)

26. The electrochemical system of claim 12,
wherein the second electrode is configured to be a counter-electrode of the first electrode; and
wherein the second electrode is configured to catalyze degradation of the target molecule during the operation of the electrochemical system.

27. (canceled)

28. The electrochemical system of claim 12, wherein the second electrode comprises a material selected from the group consisting of oxides of tin, lead, and/or titanium; platinum; and boron-shaped diamond.

29. The electrochemical system of claim 12, wherein the conductive solid substrate comprises graphite, carbon nanotube(s), and mixtures thereof.

30. The electrochemical system of claim 12, wherein the first electrode is coated onto a porous support selected from the group consisting of porous metal and porous carbon.

31. A method of separating and degrading target molecules in tandem from a fluid, comprising:
placing in the fluid a first electrode and a second electrode spaced apart from the first electrode, the first electrode comprising a solid substrate and a redox copolymer immobilized to the solid substrate, and the fluid source comprising the target molecules;
applying an electrical potential across the first electrode and the second electrode such that the redox copolymer transforms to an oxidized state and selectively binds to a target electron-donating functional group of the target molecules to provide bound target molecules; and
reversing the applied potential such that the bound target molecules are released from the first electrode and degraded on a surface of the second electrode.

32. The method of claim 31, wherein the reversing comprises catalyzing oxidative or reductive degradation of the released target molecules on the surface of the second electrode.

33. The method of claim 31, wherein the target molecules are selected from the group consisting of a perfluoroalkyl compound, a perfluoroalkyl compound, a pharmaceutical compound, a personal healthcare product, a detergent, a pesticide, a herbicide, and/or an organic wastewater contaminant.

34-48. (canceled)

49. The method of claim 31, wherein the fluid is a body of surface water, waste water, or contaminated water.

50-68. (canceled)
